(19) United States
(12) Patent Application Publication
(10) Pub. No.: US 2009/0082217 A1
(43) Pub. Date: Mar. 26, 2009

(54) Selection of nucleic acid-based sensor domains within nucleic acid switch platform

(75) Inventors: Christina D. Smolke, Pasadena, CA (US); Arwen Brown, Pasadena, CA (US); Yvonne Chen, Rowland Heights, CA (US); Midori Greenwood-Goodwin, Pasadena, CA (US)

Correspondence Address: ROPES & GRAY LLP, PATENT DOCKETING 39/41, ONE INTERNATIONAL PLACE, BOSTON, MA, 02110-2624, US

(73) Assignee: California Institute of Technology, Pasadena, CA (US)

(21) Appl. No.: 12/218,628

(22) Filed: Jul. 16, 2008

Related U.S. Application Data
(60) Provisional application No. 60/959,667, filed on Jul. 16, 2007.

(51) Int. Cl. C40B 30/02

(52) U.S. Cl. 506/9

(57) ABSTRACT

The invention relates to a method (preferably a high throughput method) for screening for functional aptamer-regulated, ligand-responsive nucleic acids, or “ampliSwitches,” and uses thereof. The subject method not only applies to large molecules, such as proteins, but also applies to relatively small ligands, such as those with molecular weight of no more than 5 kDa, 3 kDa, or 1 kDa.

### CROSS-REFERENCE TO RELATED APPLICATIONS

This application claims the benefit of the filing date under 35 U.S.C. §119(e) to U.S. Provisional Application No. 60/959,667, filed on Jul. 16, 2007, the contents of which (including the specification and drawings) are incorporated herein by reference in their entirety.

### STATEMENT REGARDING FEDERAL FUNDING

Work described herein was funded, in whole or in part, by Grant No. CBET-0545987 awarded by the National Science Foundation (NSF). The United States Government has certain rights in this invention.

### BACKGROUND OF THE INVENTION

Synthetic nucleic acid ligands, or aptamers, are versatile molecules useful in biotechnological and therapeutic applications. Aptamers present powerful tools for detecting analytes and for regulating processes in a ligand-dependent manner. Generally defined, aptamers are nucleic acid binding species that interact with high affinity and specificity to selected ligands. Aptamers have been selected to bind diverse targets such as dyes, proteins, peptides, aromatic small molecules, antibiotics, and other biomolecules (Hermann et al., Science 287: 820-825, 2000).

Several in vitro selection schemes have been used to obtain novel RNA aptamers. For example, a common approach involves immobilizing the target ligand on a solid support, then exposing this ligand-decorated surface to populations of random-sequence RNAs aptamers. Those RNA sequences that bind to the surface are selectively eluted, amplified, and further enriched by similar iterations. But according to this selection scheme, the ligand is tethered to a solid support and may contain chemical modifications that may alter or hinder full spatial access to the ligand.

### SUMMARY OF THE INVENTION

The invention generally relates to a screening method for identifying aptamer-regulated nucleic acids that bind a ligand, such as a small molecule ligand.

More specifically, the invention provides a method of screening a library of nucleic acids for a nucleic acid that binds a ligand, wherein each member of the library comprises: (a) an aptamer that potentially binds the ligand; and, (b) a functional domain, the method comprising: (1) contacting the library of nucleic acids with the ligand, under conditions that allow binding of the ligand to the aptamer of one or more members of the library in solution; (2) isolating nucleic acids that form complexes with the ligand; and, (3) determining, for each nucleic acid isolated in (2), if any, whether binding of the ligand to the aptamer favors a conformational change in the functional domain from a first ligand-free conformation to a second ligand-binding conformation, wherein the functional domain is not a ribozyme or a catalytic RNA, or wherein step (2) is not effectuated by denaturing polyacrylamide gel electrophoresis (PAGE) or a chromatography-based selection system, or both.

In certain embodiments, the method further comprises repeating once or more times steps (1)-(2) before step (3), or repeating once or more times steps (1)-(3), each time using any nucleic acids isolated in step (2) of the previous iteration or an amplification product thereof as the library in the immediate subsequent round of screening.

In certain embodiments, the conformational change is caused by a strand displacement mechanism, wherein in the first conformation, a complementary strand base pairs with a competing strand, and in the second conformation, an aptamer switching stem displaces the competing strand to base pair with the complementary strand.

In certain embodiments, each member of the library of nucleic acids comprises: (i) the aptamer, (ii) a complementary strand, (iii) an aptamer switching stem, (iv) a competing strand, (v) an antisense stem, and, wherein, in the first conformation, the aptamer unbound by the ligand allows the competing strand to base pair with the complementary strand, and the antisense stem to form a double-stranded stem-loop structure; wherein, in the second conformation, the aptamer bound by the ligand allows the aptamer switching stem to displace the competing strand and base pair with the complementary strand, and disrupts the stem-loop structure formed from the antisense stem.

In certain embodiments, the aptamer is flanked by the complementary strand and the aptamer switching stem. For example, the aptamer may be 3′ or 5′ to the complementary strand.

In certain embodiments, in the second conformation, the antisense stem is without the stem-loop structure and is capable of hybridizing with a second polynucleotide.

In certain embodiments, step (2) is carried out based on the mass-to-charge (m/z) ratio difference among the complexes, the unbound ligand, and the unbound nucleic acid.

In other embodiments, step (2) is carried out based on the availability of the competing strand (and/or part of the antisense stem sequence) for hybridization with a second polynucleotide.

In certain embodiments, members of the library of nucleic acids have substantially the same m/z ratio.

In certain embodiments, each member of the library of nucleic acids has essentially the same length.

In certain embodiments, the nucleic acid comprises ribonucleic acid (RNA), deoxyribonucleic acid (DNA), or both.

In certain embodiments, the method is carried out in vitro, preferably in high throughput.

In certain embodiments, wherein the ligand is selected from the group consisting of small molecules, metal ions, natural products, polypeptides, peptide analogs, nucleic acids, carbohydrates, fatty acids and lipids, a non-peptide hormone (such as steroids) and metabolic precursors or products thereof, and enzyme co-factors, enzyme substrates and products of enzyme-mediated reactions.

In certain embodiments, the ligand is a polypeptide, such as one no more than 20 kDa, 10 kDa, or 5 kDa in molecular weight.

In certain embodiments, the method further comprises: (4) characterizing any changes, if any, in a functional property of the nucleic acids determined to have undergone the conformation change in step (3).

In certain embodiments, the amplification product is amplified by PCR or RT-PCR.

In certain embodiments, the ligand is a small molecule no more than 5 kDa in molecular weight.

In certain embodiments, the method further comprises, before step (2): (4) contacting the mixture with a second nucleic acid that binds to the functional domain after but not before the conformational change.

In certain embodiments, the second nucleic acid is conjugated to a label, such as a biotin or a fluorescent label.

In certain embodiments, the second nucleic acid is conjugated to biotin, and the method further comprising, before step (2): (5) contacting the mixture with Avidin, Streptavidin, or an analog thereof.

In certain embodiments, step (2) is carried out by capillary electrophoresis (CE), such as equilibrium CE or non-equilibrium CE.

In certain embodiments, the aptamer comprises a randomized sequence. The randomized sequence may be about 30-50 nucleotides in length, or about 10-60 nucleotides in length.

In certain embodiments, the aptamer comprises the randomized sequence and other set structures for stabilizing the aptamer.

In certain embodiments, the functional domain comprises a priming sequence capable of hybridizing to a target template to form a primer:template pair, and wherein binding of the ligand to the aptamer favors a conformational change in the nucleic acid that alters the ability of the priming sequence to hybridize to the target template.

In certain embodiments, the primer:template pair is a substrate for an extrinsic enzymatic activity.

In certain embodiments, the extrinsic enzymatic activity is a DNA polymerase.

In certain embodiments, the polymerase is phi29 or taq polymerase.

In certain embodiments, the extrinsic enzymatic activity is a ligase.

In certain embodiments, the conformational change produces or removes an intramolecular double-stranded feature, including the priming sequence, which double-stranded feature alters the availability of the priming sequence to hybridize to the target template.

In certain embodiments, the functional domain is: (1) a substrate sequence that can form a substrate for an extrinsic enzyme, and (2) binding of the ligand to the aptamer favors a conformational change in the nucleic acid that alters the ability of the substrate sequence to form the substrate and/or alters the Kₘ and/or k_{cat} of the substrate for the extrinsic enzymatic activity.

In certain embodiments, the conformational change produces or removes an intramolecular double-stranded feature, including the substrate sequence, which double-stranded feature is the substrate for the extrinsic enzyme.

In certain embodiments, the extrinsic enzyme is an RNase III enzyme, such as Dicer or Drosha.

In certain embodiments, the nucleic acid causes gene silencing in a manner dependent on the ligand binding to the aptamer, the RNase III enzyme, and the sequence of the substrate sequence.

In certain embodiments, the substrate sequence produces siRNA, miRNA or a precursor or metabolite thereof in an RNA interference pathway, as a product of reaction with the RNase III enzyme.

In certain embodiments, the siRNA, miRNA or precursor or metabolite thereof is between about 19-35 nucleotides in length, or about 21-23 nucleotides in length.

In certain embodiments, the conformation change alters the ability of the substrate sequence to form an intermolecular double-stranded feature with a second nucleic acid species, which double stranded feature is a substrate for the extrinsic enzyme.

In certain embodiments, the second nucleic acid species is an mRNA, and the extrinsic enzyme alters the mRNA in a manner dependent on the formation of the double-stranded feature.

In certain embodiments, the extrinsic enzyme is an RNase H enzyme and/or an RNase P enzyme.

In certain embodiments, the effect of the ligand on the ability of the substrate sequence to form the substrate and/or alters the Kₘ and/or k_{cat} of the substrate for the extrinsic enzyme exhibits dose dependent kinetics.

In certain embodiments, the substrate sequence comprises a hairpin loop.

In certain embodiments, the functional domain is a ribozyme, and wherein binding of the ligand to the aptamer favors a conformational change in the nucleic acid that alters the activity of the ribozyme.

In certain embodiments, the nucleic acid further comprises a functional group or a functional agent.

In certain embodiments, the aptamer is responsive to pH, temperature, osmolarity, or salt concentration.

In certain embodiments, the aptamer of the nucleic acid is altered so that it is more or less amenable to ligand binding.

In certain embodiments, the nucleic acid includes one or more non-naturally occurring nucleoside analogs and/or one or more non-naturally occurring backbone linkers between nucleoside residues.

In certain embodiments, the nucleic acid has a different stability, susceptibility to nucleases and/or bioavailability relative to a corresponding nucleic acid of naturally occurring nucleosides and phosphate backbone linkers.

In certain embodiments, the nucleic acid is in the size range of 50-200 nucleotides.

In certain embodiments, the nucleic acid comprises one or more aptamers or one or more effector domains.

In certain embodiments, the nucleic acid interacts with and responds to multiple ligands.

In certain embodiments, the nucleic acid is a cooperative ligand controlled nucleic acid wherein multiple ligands sequentially bind to multiple aptamers to allosterically regulate one or more effector domains.

The embodiments and practices of the present invention, other embodiments, and their features and characteristics, will be apparent from the description, figures and claims that follow, with all of the claims hereby being incorporated by this reference into this Summary.

It is contemplated that any embodiments described herein, including those only described under one of the many aspects of the invention, can be combined with any other embodiments described under any aspects of the invention whenever appropriate.

### BRIEF DESCRIPTION OF THE DRAWINGS

FIG. 1 shows a not-to-scale, schematic drawing of an exemplary switch of the subject invention. The different modular parts of this switch are represented in different dashed boxes. 1 is an aptamer or aptamer domain; 2 is an antisense stem (which typically takes the form of a stem-loop structure); 3 is a complementary strand (part of which, when hybridized with the competing strand, may form a duplex region that is continuous with the antisense stem); 4 is an aptamer switching stem (at least part of which competes with the competing strand to hybridize with the complementary strand); and 5 is a competing strand (at least part of which competes with the aptamer switching stem to hybridize with the complementary strand). Other design choices with the same or different elements shown here are also possible.

FIG. 2A is a schematic drawing showing a modified selection scheme for directly generating an RNA switch molecule responsive to a target ligand. A similar schedule can be used for selecting a DNA switch. FIG. 2B is a schematic drawing showing the ability to directly partition bound from unbound switches for protein ligands due to significant change in the m/z ratio between these two pools. FIG. 2C is a schematic drawing showing the inability to directly partition bound from unbound switches for small molecule ligands due to similar m/z ratios between these two pools. A modified complex selection scheme is illustrated in which the binding of the antisense strand to a target biotin (B)-labeled oligonucleotide (DNA and/or RNA) and subsequent binding to Streptavidin (SA) results in a complex with a significantly altered m/z ratio.

FIG. 3 shows switch designs for (a) a PDGF-responsive DNA switch (SEQ ID NO: 1), (b) a trans-androsterone-responsive DNA switch (SEQ ID NO: 2), and (c) a theophylline-responsive RNA switch (SEQ ID NO: 3). The ΔG values included in (c) refer to the free energy of hybridization for the specified strand.

FIG. 4 shows the sequences of the three switches pictured in FIG. 3 and their corresponding linker sequences (SEQ ID NOs: 4-6, respectively). The Δ(ΔG) values given are calculated as (ΔG_{hybridization} of the aptamer switching strand with the complementary strand)−(ΔG_{hybridization} of the competing strand with the complementary strand, plus ΔG_{hybridization} of the antisense stem).

FIG. 5 shows Capillary Electrophoresis (CE) electropherograms of chemically-synthesized PDGF control switch shown in FIG. 3a. (5A) 2.5 μM PDGF switch control with 2.5 μM linker complexed with Streptavidin (SA). (5B) An equilibrium mixture with 2.5 μM PDGF and 1 μM PDGF. (5C) 2.5 μM PDGF switch, 1 μM PDGF and 2.5 μM linker complexed with SA. (5D) Close-up comparison of (5B) and (5C).

FIG. 6 shows CE electropherograms of chemically-synthesized trans-androsterone (TA) control switch shown in FIG. 3b. (6A) 2.5 TA control switch alone. (6B) 2.5 TA control switch with 400 μM TA.

FIG. 7 shows CE electropherograms of chemically-synthesized trans-androsterone (TA) control switch with binding buffer Tris-MgCl₂. Green: 5 μM TA switch, 5 μM linker, 0.5 μM Streptavidin, 50 μM TA; blue: 5 μM TA switch, 5 μM linker, 0.5 μM Streptavidin, 0 μM TA; black: 5 μM TA switch, 0 μM linker, 0 μM Streptavidin, 50 μM TA.

FIG. 8 shows agarose gel electrophoresis analysis of the theophylline-responsive RNA switch. Lane 1: 100 bp ladder; lane 2: PCR of DNA switch template; lane 3: PCR without template; lane 4: RNA switch after transcription of PCR product.

FIG. 9 shows CE electropherograms of chemically synthesized NF-kB RNA aptamer responsive to NF-kB protein. Blue: 0.88 μM NF-kB aptamer and 120 nM NF-kB in 10 mM HEPES, 0.1 mM NaCl, 1 mM DTT binding buffer; green: 0.88 μM NF-kB aptamer in the same binding buffer.

FIG. 10 shows CE electropherograms recorded with LIF (laser-induced fluorescence) detector of chemically synthesized NF-kB RNA aptamer responsive to NF-kB protein. Red: 0.62 μM NF-kB aptamer and 250 nM NF-kB in 10 mM HEPES, 0.1 mM NaCl, 1 mM DTT binding buffer; black: 0.62 μM NF-kB aptamer in the same binding buffer.

FIG. 11 shows CE electropherograms recorded at 254 nm of chemically synthesized NF-kB RNA aptamer responsive to NF-kB protein. Pink: 1 μM NF-kB aptamer and 0.2 μM NF-kB in TGK binding buffer; blue: 0.2 μM NF-kB protein in TGK binding buffer; black (2^{nd} electropherogram from the bottom): TGK binding buffer; black: 1 μM NF-kB aptamer in TGK binding buffer.

FIG. 12 shows agarose gel electrophoresis analysis of PCR amplification off of the collections from the NF-kB aptamer spiked in a random N40 library in a 1 to 10 ratio and NF-kB protein equilibrium mixture. Lane 1: 100 bp ladder; lane 2: C1 (first collection time 7.40 to 10.70 minutes); lane 3: D1 (second collection time 10.70 to 15.90 minutes); lane 4: E1 (third collection time 15.90 to 19.20 minutes); lane 5: no template control; lane 6: N40 template control.

FIG. 13 shows agarose gel electrophoresis analysis of transcription of previous collection PCR samples shown in FIG. 12. Lane 1: 100 bp ladder; lane 2: C1 transcription product; lane 3: D1 transcription product; and lane 4: E1 transcription product.

FIG. 14 shows CE electropherograms recorded at 254 nm of chemically synthesized NF-kB RNA aptamer spiked into a random N40 RNA library. Pink: 1 μM random N40 library only; green: first round of selection, 0.3 μM NF-kB aptamer, ˜3 μM N40 library, 1 μM NF-kB protein; blue: second round of selection following PCR amplification and transcription of C1 collection sample, unknown NF-kB aptamer and N40 library concentrations with 1 μM NF-kB protein; black: second round of selection following PCR amplification and transcription of C1 collection sample, unknown NF-kB aptamer and N40 library concentrations with 0 μM NF-kB protein.

### DETAILED DESCRIPTION OF THE INVENTION

### 1. Overview

Aptamers may become parts of aptamer-regulated nucleic acids, which regulate other molecules in a ligand-dependent manner by acting as “switches.” An aptamer-regulated nucleic acid, or switch, typically comprises two primary domains: first, an aptamer domain (in short “aptamer” as used herein) that can bind a ligand, and second, a functional domain. The switch molecule can adopt two different conformations or states that are typically in equilibrium or approaching equilibrium through, for example, an allosteric or conformational change. One of the switch states has the correctly formed aptamer that can bind the ligand, together with a (first) conformation of the functional domain. This state may be called the “ligand-binding state/conformation.” Once a ligand binds to the ligand-binding state/conformation of the switch, the switch and the aptamer is “ligand-bound.” The other switch state does not have the correctly formed aptamer and thus cannot bind the ligand. Consequently, this state may be called the “ligand-free state/conformation.” The ligand-free state may be associated with a different (second) conformation of the functional domain. When the ligand is present, it binds to one of those states (the ligand-binding state) and therefore shifts the equilibrium to favor that conformation of the switch and the functional domain.

At the macro-level, it appears that contacting the ligand with the switch (with two conformations or states) “induces” a conformational change in the switch to favor the ligand-binding state (and its associated functional domain conformation), although mechanistically, the ligand may not bind the ligand-free switch state (and its associated functional domain conformation). Therefore, “induce a conformational change (of the switch)” or similar terms as used herein refers to this macro-level equilibrium shift between the switch states, and does not necessarily imply that the ligand actually binds to the ligand-free switch state and induces a conformation change of this state to become the ligand-binding switch state.

The functional domain may also be called an effector domain in some embodiments. As described above, the functional domain of the subject switch molecule has at least two conformational states, one may be called an “off” state (less functional or non-functional state), and the other an “on” state (more functional or functional state). Either the off state or the on state may be associated with the switch conformation that can bind the ligand. Thus in one scenario, binding of a ligand to the aptamer domain shifts the equilibrium to a switch state with a functional domain that interacts with its target. In contrast, in a related scenario, the ligand-binding state of the switch may be characterized by the inability of the associated functional domain to interact with its target. In either case, the aptamer-regulated nucleic acid acts as a “switch” whose activity is turned “on” or “off” in response to ligand or analyte binding. This switch platform enables ligand-dependent control of functional domain activity through ligand-binding by the aptamer.

Given the capacity to create synthetic nucleic acids with novel functional properties, the generation and selection of appropriate aptamers becomes critical. Existing methods rely on iterative cycles of selection and amplification, known as in vitro selection, or SELEX (Systematic Evolution of Ligands by Exponential enrichment) (see Ellington et al., Nature 346: 818-822, 1990; and Tuerk et al., Science 249: 505-510, 1990). Initially, a starting pool of nucleic acids is generated and screened a rapid and parallel manner, using for example, high-throughput methods and laboratory automation (Cox et al., Nucleic Acids Res 30: e108, 2002). In a standard oligonucleotide synthesizer, 10¹⁵ or more different molecules can be synthesized at once. The starting pool (e.g., those with a diversity of up to about 10¹⁵ different molecules) is then screened for desired properties, such as binding to ligands of choice, and the candidate molecules are separated from the starting pool. Candidate molecules are sparsely represented in the starting pool, such that additional amplification and selection steps usually must be carried out. Standard strategies for generating new aptamer sequences typically require 10-15 selection cycles, which limits the efficiency of the selection scheme. Also limiting are the separation steps that isolate candidate molecules from the pools. Separation typically depends on affinity-based methods such as affinity chromatography, where ligands are immobilized on solid supports. The attachment of ligands to the solid support is further limited by standard chemistries. Capillary Electrophoresis (CE) is a rapid and high efficiency partitioning scheme for separating molecules or complexes based on mass-to-charge ratio (m/z ratio). Schemes making use of either an equilibrium or a non-equilibrium capillary electrophoresis (CE) separation can be readily applied to separate large protein-binding aptamers. Using this method, aptamers are separated by their charge and frictional forces. Aptamers that bind to ligands will typically have a different mass-to-charge (m/z) ratio compared to aptamers that do not bind ligands, and thus they will migrate at a different rate from the rest of the unbound pool. If the difference in m/z ratio is large enough (e.g., when the ligand is a large protein), the ligand-bound nucleotides can be separated from the free ligands and the ligand-free nucleotides. Due to the much greater efficiency of partitioning with this method over affinity-based procedures, aptamers may be generated in fewer cycles (typically 2-4 cycles).

As used herein, mass-to-charge (m/z) ratio of any molecule or complex can be calculated by dividing total mass (e.g., molecular weight) of the molecule or complex by net charge. Calculation of the total mass may take into consideration the specific forms of the molecule or complex under specific conditions, such as the condition of capillary electrophoresis (pH, temperature, salts present and their concentrations, etc.). The net charge may also become affected by the specific conditions of separation (such as pH, temperature, salts present and their concentrations, etc.).

However, aptamers selected based on the direct-select scheme described above may not be in appropriate formats for placement within a nucleic acid switch platform. The selected aptamers, when later used in molecular switch platforms, frequently fail to cause conformational changes in the switch context, probably due to the presence of additional sequences at one or both ends of the aptamer in the switch context. In addition, high affinity aptamers selected based on this scheme may not retain the same high affinity in the switch context. Conversely, it is at least theoretically possible that certain aptamers exhibiting high affinity to ligands in a switch context may not exhibit high enough affinity to the same ligand when not in the switch context, and thus such aptamers could be lost during the initial selection process outside the context of the switch.

Perhaps more importantly, the selection scheme may not usually work for aptamers that bind small molecules (including small polypeptides), especially in CE-based separation, partly because the binding of small molecules to aptamers generally do not cause a sufficiently large change in mass-to-charge ratio that can facilitate the separation of ligand-bound aptamers from ligand-free aptamers.

Thus in one aspect, the present invention provides a rapid and efficient aptamer selection scheme for identifying aptamers that bind a given target molecule in the context of a switch platform (e.g., the candidate nucleic acids subject to the screening contain sequences not related to the binding of the target molecule, such as at least one functional domain). Such screening methods are applicable to large and small molecules alike. Preferably, the selected aptamer, upon binding the target molecule, favors a conformation change of the switch, from its ligand-free conformation to a ligand-binding conformation. Preferably, the conformation change leads to a change (e.g., either an increase or a decrease) in an activity of a functional domain within the switch.

In certain embodiments, the target molecule is a small molecule that, upon binding to a candidate nucleic acid, does not impart sufficient mass-to-charge ratio change between the ligand-bound and the ligand-free aptamer-containing nucleic acid. For example, the small molecule target may be no more than about 5 kDa, 4 kDa, 3 kDa, 2.5 kDa, 2 kDa, 1.5 kDa, 1 kDa, 0.5 kDa, 0.2 kDa, or even about 0.1 kDa in molecular weight. In such embodiments, the subject invention provides methods to increase the m/z ratio difference between the ligand-bound and the ligand-free aptamer-containing nucleic acid, by, for example, hybridizing a second nucleic acid either to the ligand-bound (and ligand-binding) or the ligand free form of the aptamer-containing nucleic acid, but not both. The conformation change in the aptamer-containing nucleic acid upon ligand binding renders it possible for the aptamer-containing nucleic acid either to bind or not to bind the second nucleic acid.

The hybridization to the second nucleic acid preferably occurs at the functional domain. However, in the case where the functional domain is a ribozyme or a catalytic RNA, the activated ribozyme may self-cleave or cleave a substrate in trans. This property may be used to design additional second nucleic acids for separating ligand-bound and ligand-free aptamer-regulated nucleic acids. For example, the second nucleic acid may be designed so that it binds one conformation (e.g., the ligand-free conformation) but not the other conformation (e.g., the ligand-bound conformation). The binding site may be at the site of strand displacement, or at the site exposed by riboswitch self-cleavage. Alternatively, the second nucleic acid may bind to a common region on both conformations, while the active riboswitch will cleave the second nucleic acid to either create a m/z ratio difference or to remove a tag on the second nucleic acid required for affinity purification/depletion (see below). Such binding by the second nucleic acid may provide a basis for separation based on m/z ratio difference, or affinity purification/depletion (optionally in conjunction with a tag, such as a biotin tag that can bind Avidin or Streptavidin), allowing one conformation to be removed and the other conformation to be collected.

The second nucleic acid may contain modified nucleotides to effect changes in the m/z ratio. For example, the modification may occur at the phosphodiester linkage (to change charge), at the base or sugar ring (to change mass and/or charge), or a mixture thereof. For example, the second nucleic acid may be a PNA (infra), or modified at one or more phosphodiester linkages to include a phosphorothioate, a phosphorodithioate, a phosphoramidothioate, a phosphoramidate, a phosphordiamidate, a methylphosphonate, an alkyl phosphotriester, a formacetal or an analog thereof.

The second nucleic acid may also be directly or indirectly “tagged” with a moiety with sufficient molecular weight, such that the complex containing the tagged second nucleic acid has an adequate change in the overall m/z ratio. For example, the second nucleic acid may be directly tagged with a protein or any other chemical group that does not negatively impact (inhibit or decrease) its hybridization ability. Alternatively, the second nucleic acid may be indirectly linked to a large molecule through an adapter, such as a covalently-linked biotin, so that a large protein (such as Avidin, Streptavidin, or analogs thereof) or other adapter-binding molecules can be indirectly attached to the complex.

“Switch,” “Switch platform,” “ampliSwitch,” “aptaSwitch” and “aptamer-regulated or aptamer-containing nucleic acid” are used interchangeably herein to refer to nucleic acids that respond to binding to a ligand or analyte of interest, usually capable of a conformation change from a conformation that does not bind the ligand (the ligand-free conformation) to a conformation that can bind the ligand (the ligand-binding conformation).

More specifically, the invention provides, in one aspect, a method of screening a library of nucleic acids for a nucleic acid that binds a ligand, wherein each member of the library comprises: (a) an aptamer that potentially binds the ligand; and, (b) a functional domain, the method comprising: (1) contacting the library of nucleic acids with the ligand, under a condition that allows binding of the ligand to the aptamer of one or more members of the library in solution; (2) isolating nucleic acids that form complexes with the ligand; and, (3) determining, for each nucleic acids isolated in (2), if any, whether binding of the ligand to the aptamer favors a conformational change in the functional domain from a first ligand-free conformation to a second ligand-binding or ligand-bound conformation.

In certain embodiments, after isolating aptamer-regulated nucleic acids, the method further comprises: (4) characterizing changes, if any, in functional properties of the nucleic acids determined to have undergone the conformation change in step (3).

As used herein, “library” includes two or more members. However, in certain embodiments, the subject library includes about 10² non-redundant members, about 10³ non-redundant members, about 10⁴ non-redundant members, about 10⁵ non-redundant members, about 10⁶ non-redundant members, about 10⁷ non-redundant members, about 10⁸ non-redundant members, about 10⁹ non-redundant members, about 10¹⁰ non-redundant members, about 10¹¹ non-redundant members, about 10¹² non-redundant members, about 10¹³ non-redundant members, about 10¹⁴ non-redundant members, about 10¹⁵ non-redundant members, about 10¹⁶ non-redundant members, about 10¹⁷ non-redundant members, about 10¹⁸ non-redundant members, about 10¹⁹ non-redundant members, or about 10²⁰ non-redundant members. In certain embodiments, the library may be screened all at the same time, or separately, each with smaller portions of the entire non-redundant library. Each of these smaller libraries may be screened sequentially, in parallel, or in combination. The libraries may be screened in high-throughput fashion, or in batch, preferably automatically using robotic/automatic instruments capable of handling multiple samples simultaneously.

In certain embodiments, the ligand and aptamer-regulated nucleic acid bind in solution, including in vivo (e.g., inside a cell). For example, a functional screening may be used to isolate nucleic acids that form complexes with the ligand. According to this embodiment, the library may be introduced into a population of cells (bacteria, yeast, mammalian, human cells, etc.), preferably with less than one aptamer-regulated nucleic acid per cell on average. The cells can be in contact with the ligand, which favors one but not the other conformation of the switch. The active form of the switch may regulate the expression of a marker gene (such as a fluorescent protein, an enzyme, etc.), or an essential gene required for cell growth (e.g., an essential gene required to metabolize a nutrient upon which the cell depends on to survive). Thus ligand binding may either allow a cell to survive or kills the cell.

In certain embodiments, neither the library nor the ligand are immobilized, directly or indirectly, e.g., on a solid support. In other words, the library contacts the ligand in solution without the constraint of any moieties or chemical groups necessary for immobilization on solid support (such as beads, columns, or other solid substrates).

In certain embodiments, there can be multiple iterations of similar binding and selection steps (1) and (2), such that any aptamer-regulated nucleic acid capable of binding to the ligand in a previous iteration is either used directly or amplified using any art-recognized means (such as PCR for DNA or RT-PCR for RNA), as the library for the next round of selective binding. Optionally and independently, for each iteration, step (3) may be included to ensure that there is a conformation change upon ligand binding.

Thus according to this embodiment of the invention, the method may further comprise repeating once or more times steps (1)-(2) before step (3), or repeating once or more times steps (1)-(3), each time using any nucleic acids isolated in step (2) of the previous iteration or an amplification product thereof as the library in the immediate subsequent round of screening.

In certain embodiments, the conformation change may be caused by a strand displacement mechanism, such that in the first conformation, a complementary strand of the subject nucleic acid base pairs with a competing strand of the subject nucleic acid, and in the second conformation, an aptamer switching stem of the subject nucleic acid displaces the competing strand to base pair with the complementary strand.

There can be many possible configurations of the subject library of nucleic acids. In one of the exemplary embodiments, each member of the library of nucleic acids comprises: (i) the aptamer, (ii) a complementary strand, (iii) an aptamer switching stem, (iv) a competing strand, (v) an antisense stem, and, wherein, in the first conformation, the aptamer unbound by the ligand allows the competing strand to base pair with the complementary strand, and the antisense stem to form a double-stranded stem-loop structure; wherein, in the second conformation, the aptamer bound by the ligand allows the aptamer switching stem to displace the competing strand and base pair with the complementary strand, and disrupts the stem-loop structure formed from the antisense stem.

Although there can be many different configurations, in certain exemplary embodiments, the aptamer is flanked by the complementary strand and the aptamer switching stem. For example, the aptamer may be 3′ or 5′ to the complementary strand.

In certain embodiments, in one of the two conformations (e.g., the second conformation), the antisense stem is without the stem-loop structure and is capable of hybridizing with a second polynucleotide. In contrast, in the other conformation (e.g., the first conformation), the antisense stem becomes part of the stem-loop structure, and is therefore incapable of hybridizing with the second polynucleotide. Partly due to this difference, the second polynucleotide (in its modified form, or in a form that is directly or indirectly tagged with a large molecular weight moiety) may be used to increase the m/z ratio difference between the ligand-bound (and ligand-binding) and the ligand-free conformations, thereby allowing the separation of these two conformations based on the m/z ratio difference even when the ligand is of relatively small molecular weight.

Thus, for example, when the ligand is a relatively small molecule, such that the m/z ratio difference between the ligand-bound nucleic acid and the ligand-free version is not sufficiently large to allow efficient separation, the method may further comprise, before step (2): (4) contacting the mixture with a second nucleic acid that binds to the functional domain after but not before the conformational change. According to this embodiment, the ligand-bound form of the nucleic acid can hybridize with the second nucleic acid. After the hybridization, the ligand-bound form has a substantially larger m/z ratio due to the presence of the hybridizing second nucleic acid (e.g., in its modified form or the directly/indirectly tagged form), thus becomes much easier to isolate from the mixture of unbound nucleic acids and unbound ligands.

It is also possible, in another embodiment, to further comprise, before step (2): (4) contacting the mixture with a second nucleic acid that binds to the functional domain before but not after the conformational change. According to this embodiment, the second polynucleotide binds the ligand-free form of the aptamer-regulated nucleic acid. If properly selected, the ligand-bound form will have a much different m/z ratio (e.g., smaller) compared to the ligand-free nucleic acid hybridizing with the second polynucleotide (e.g., in its modified form or the directly/indirectly tagged form), thus allowing the separation of these two forms (and the free ligands).

In either embodiment, the second nucleic acid may be directly or indirectly conjugated to a label, such as a biotin label or a fluorescent label (GFP, EGFP, YFP, etc.). The biotin label may be present on the second nucleic acid before the labeled second nucleic acid is in contact with the aptamer-regulated nucleic acids. Avidin or streptavidin can then be added to the reaction mixture. Alternatively, the biotin-labeled second nucleic acid may be bound by Avidin or Streptavidin before it is in contact with the aptamer-regulated nucleic acids.

In certain embodiments, when biotin is used as a label, the method may further comprise, before step (2): (5) contacting the mixture with Avidin, Streptavidin, or an analog thereof.

Avidin is a tetrameric protein produced in the oviducts of birds, reptiles and amphibians which is deposited in the whites of their eggs. The tetrameric protein contains four identical subunits (homotetramer), each of which can bind to biotin (Vitamin H) with a high degree of affinity and specificity. The dissociation constant of Avidin is measured to be K_{D}≈10⁻¹⁵ M, making it one of the strongest known non-covalent bonds. In its tetrameric form, Avidin is estimated to be between 66-69 kDa in size. About 10% of the molecular weight is attributed to carbohydrate content composed of four to five mannose and three N-acetylglucosamine residues. The carbohydrate moieties of Avidin contain at least three unique oligosaccharide structural types which are similar in structure and composition.

As a basically charged glycoprotein, Avidin may exhibit certain non-specific binding in some applications. NeutrAvidin, a deglycosylated Avidin with modified arginines, exhibits a more neutral pI and may be used as an alternative or analog to native Avidin where problems of non-specific binding arise. Deglycosylated, neutral forms of Avidin are available through Sigma-Aldrich (EXTRAVIDIN™), Thermo Scientific (NeutrAvidin), Invitrogen (NeutrAvidin) and Belovo (NEUTRALITE™), etc.

In certain embodiments, it may be desirable to separate the biotin-Avidin binding in the screening process. Given the strength of the Avidin-biotin bond, dissociation of the Avidin-biotin complex requires extreme conditions that may be undesirable. Thus in these embodiments, an Avidin analog with reversible binding characteristics through nitration or iodination of the binding site tyrosine may be used (Morag et al., Biochem. J. 316: 193-199, 1996, incorporated by reference). The modified Avidin exhibits strong biotin binding characteristics at pH 4 and releases biotin at a pH of 10 or higher. In addition, a monomeric form of Avidin with a reduced affinity for biotin is also employed in many commercially available affinity resins. The monomeric Avidin is created by treatment of immobilized native Avidin with urea or guanidine HCl (6-8 M), giving it a lower K_{D}≈10⁻⁷ M (Kohanski & Lane, Methods in Enzymology 183: 194, 1990, incorporated by reference). This allows elution from the Avidin matrix to occur under milder, non-denaturing conditions, using low concentrations of biotin or low pH conditions.

A non-glycosylated form of Avidin has also been isolated from commercially prepared product, and may be used as an Avidin analog (Hiller et al., Biochem. J. 248: 167-171, 1987, incorporated by reference).

Streptavidin is a 53 kDa tetrameric protein purified from the bacterium Streptomyces avidinii. It also has extraordinarily strong affinity for the vitamin biotin—the dissociation constant (K_{D}) of the biotin-Streptavidin complex is on the order of ˜10⁻¹⁵ M, ranking among one of the strongest known non-covalent interactions.

There are considerable differences in the composition of Avidin and Streptavidin, but they are remarkably similar in other respects. Both proteins form tetrameric complexes to function, in which each subunit can bind one molecule of biotin. Guanidine hydrochloride will dissociate both Avidin and Streptavidin tetramers into their component subunits, but Streptavidin is more resistant to dissociation. Streptavidin is much less soluble in water than Avidin, and it lacks Avidin's extensive glycosylation. Streptavidin has a mildly acidic isoelectric point (pI) of ˜5. A recombinant form of Streptavidin with a mass of 53 kDa and a near-neutral pI is also commercially available. Because Streptavidin lacks any carbohydrate modification and has a near-neutral pI, it has the advantage of much lower non-specific binding than Avidin. Deglycosylated Avidin is more comparable to the size, pI and nonspecific binding of Streptavidin.

Techniques to conjugate biotin to polynucleotides are well-known in the art. One technique involves first digesting DNA with a restriction exonuclease to produce either a blunt end, a 3′ overhang or a 5′ overhang. The DNA is then incubated with biotin-11-dUTP, a deoxyribonucleotide analog that is covalently attached to biotin, and the Klenow fragment of the holoenzyme DNA polymerase I of E. coli. The biotin-11-dUTP is incorporated into the 3′ end of the strand complementary to the 5′ ssDNA portion of the overhang. Assuming care is taken to ensure that only one 5′ overhang with only one possible site is available for dUTP incorporation, the result is a strand of DNA with a biotinylated end. This biotinylated DNA may be used for binding (via non-covalent interactions) to Avidin or Streptavidin.

In certain embodiments, Avidin or Streptavidin may be used to coat agarose microspheres, polystyrene or even paramagnetic beads. These complexes may be used for purification or isolation of biotin-tagged polynucleotides or complexes encompassing the ligand-bound aptamer-regulated nucleic acids.

There can be many different ways to separate (or at least to enrich) ligand-bound nucleic acids from ligand-free nucleic acids. In certain embodiments, as described above, isolation step (2) can be carried out based on the m/z ratio difference among the complexes, the unbound ligand, and the unbound nucleic acid. For example, the ligand-nucleic acid complex may have a larger, smaller, or intermediate m/z ratio compared to either the unbound ligand or the unbound nucleic acid (partly depending on the charge on the ligand itself). Thus methods that separate molecules based on m/z ratio, such as CE, may be used to isolate the complex directly, or the nucleic acid that forms the complex, depending on whether equilibrium CE or non-equilibrium CE is used.

In an alternative embodiment, the isolation step (2) may be carried out based on the availability of the competing strand and/or at least parts of the antisense stem for hybridization with a second polynucleotide. For example, when the competing strand, in one conformation, is available for hybridization with the second polynucleotide, the second polynucleotide may be fixed to a solid support (such as a column, array, or bead) to capture the exposed competing strand nd/or at least parts of the antisense stein, thereby isolating the subject nucleic acid in one conformation from the other conformation where the competing strand is not available for hybridization with the second polynucleotide. The conformation in which the competing strand is available for hybridization may be the ligand-binding conformation, or the ligand free conformation.

In certain embodiments, members of the library of nucleic acids have substantially the same m/z ratio. In certain other embodiments, each member of the library of nucleic acids has essentially the same length. In certain embodiments, the method may be carried out in vitro, preferably in high throughput.

Essentially any type of ligands may be use to select the subject switch-based nucleic acids. For instance, the ligands may be small molecules, metal ions, natural products (naturally existing products), polypeptides, peptide analogs, nucleic acids, carbohydrates, fatty acids and lipids, a non-peptide hormone (such as steroids) and metabolic precursors or products thereof, enzyme co-factors, enzyme substrates, products of enzyme-mediated reactions, signal transduction second messenger molecules, post-translationally modified proteins, etc.

In certain embodiments, the ligand may be a polypeptide, such as a large polypeptide with a molecular weight of at least about 20 kDa, 30 kDa, 40 kDa, 50 kDa, 75 kDa, 100 kDa, 150 kDa, or 250 kDa or above.

In certain embodiments, the polypeptide may be a small polypeptide, such as those no more than 20 kDa, 10 kDa, or 5 kDa in molecular weight. In certain related embodiments, the ligand is a small molecule no more than 5 kDa in molecular weight, or no more than 4 kDa, 3 kDa, 2.5 kDa, 2 kDa, 1.5 kDa, 1 kDa, 0.5 kDa, 0.2 kDa, or even about 0.1 kDa in molecular weight. In certain embodiments, the ligand is a small molecule having a molecular weight of less than 2500 Dalton, and/or is cell permeable.

The aptamer of the subject aptamer-regulated nucleic acids in the library may comprise a randomized sequence. For example, the randomized sequence can be about 10-60 nucleotides in length, or about 30-50 nucleotides in length. In certain embodiments, the aptamer may also comprise other set structures for stabilizing the aptamer.

There can be many different types of functional domains in the subject aptamer-regulated nucleic acids in the library. More details are described in the sections below. For example, in certain embodiments, the functional domain may comprise a priming sequence capable of hybridizing to a target template to form a primer:template pair, and wherein binding of the ligand to the aptamer favors a conformational change in the nucleic acid that alters the ability of the priming sequence to hybridize to the target template. In certain embodiments, the conformational change produces or removes an intramolecular double-stranded feature, including the priming sequence, which double-stranded feature alters the availability of the priming sequence to hybridize to the target template.

In certain embodiments, the primer:template pair can become a substrate for an extrinsic enzymatic activity, such as a DNA polymerase activity (e.g., phi29 or taq polymerase), or a ligase activity.

In certain embodiments, the functional domain may be: (1) a substrate sequence that can form a substrate for an extrinsic enzyme, and (2) binding of the ligand to the aptamer favors a conformational change in the nucleic acid that alters the ability of the substrate sequence to form the substrate and/or alters the Kₘ and/or k_{cat} of the substrate for the extrinsic enzymatic activity.

For example, the extrinsic enzyme may be an RNase III enzyme, such as Dicer or Drosha, or analogs thereof. The nucleic acid may be a ribonucleic acid (RNA), which may optionally include one or more non-naturally occurring nucleoside analogs and/or one or more non-naturally occurring backbone linkers between nucleoside residues. Preferably, the nucleic acid has a different stability, susceptibility to nucleases and/or bioavailability relative to a corresponding nucleic acid of naturally occurring nucleosides and phosphate backbone linkers.

In certain embodiments, the nucleic acid is in the size range of about 50-200 nucleotides, 50-100 nucleotides, 100-200 nucleotides, 50-150 nucleotides, or 150-200 nucleotides, etc.

In certain embodiments, the conformational change produces or removes an intramolecular double-stranded feature, including the substrate sequence, which double-stranded feature is the substrate for the extrinsic enzyme.

In certain embodiments, the nucleic acid causes gene silencing in a manner dependent on the ligand binding to the aptamer, the RNase III enzyme, and the sequence of the substrate sequence. For example, the substrate sequence may produce siRNA, miRNA or a precursor or metabolite thereof in an RNA interference pathway, as a product of reaction with the RNase III enzyme. The siRNA, miRNA or precursor or metabolite thereof may be between about 19 and about 35 nucleotides in length, or between about 21 and about 23 nucleotides in length.

In certain embodiments, the conformation change alters the ability of the substrate sequence to form an intermolecular double-stranded feature with a second nucleic acid species, which double stranded feature is a substrate for the extrinsic enzyme. For example, the second nucleic acid species may be an mRNA, and the extrinsic enzyme alters the mRNA in a manner dependent on the formation of the double-stranded feature.

In any of the embodiments above, the extrinsic enzyme can be an RNase H enzyme and/or an RNase P enzyme.

In certain embodiments, the effect of the ligand on the ability of the substrate sequence to form the substrate and/or alters the Kₘ and/or k_{cat} of the substrate for the extrinsic enzyme exhibits dose dependent kinetics.

In certain embodiments, the substrate sequence may comprise a hairpin loop. In certain embodiments, the nucleic acid may further comprise a functional group or a functional agent. In certain embodiments, the aptamer may be responsive to pH, temperature, osmolarity, or salt concentration. In certain embodiments, the aptamer may be responsive to tonicity for impermeable solutes, such that the aptamer responds to the osmotic pressure gradient as well as the actual solute/ligand concentrations. In certain embodiments, the aptamer of the nucleic acid may be altered so that it is more or less amenable to ligand binding. In certain embodiments, the nucleic acid may comprise one or more aptamers or one or more effector domains. In certain embodiments, the nucleic acid may interact with and respond to multiple ligands. In certain embodiments, the nucleic acid may be a cooperative ligand-controlled nucleic acid, wherein multiple ligands sequentially bind to multiple aptamers to allosterically regulate one or more effector domains.

In certain embodiments, the functional domain is not a ribozyme or a catalytic nucleic acid that contains an enzymatic activity (e.g., self-cleaving or cleaving other nucleic acids). The ribozyme may, e.g., self-cleave between stems I and III of the hammer-head ribozyme.

In certain embodiments, the ligand is not a metal ion.

In certain embodiments, the functional domain is a ribozyme or a catalytic nucleic acid that contains an enzymatic activity, wherein the aptamer-regulated nucleic acid is not isolated/separated by PAGE (polyacrylamide electrophoresis, such as denaturing PAGE) or a chromatography-based selection system (where the key to the separation is the differing affinities among analyte(s), the stationary phase, and the mobile phase); or wherein the aptamer-regulated nucleic acid is not labeled (e.g., internally or at the 5′ or 3′ end) by a marker (for example, a radio-isotope).

In certain embodiments, the functional domain is not a ribozyme or a catalytic nucleic acid (e.g., catalytic RNA) that contains an enzymatic activity, and/or the aptamer-regulated nucleic acid is not isolated/separated by PAGE.

Once an aptamer sequence has been successfully identified, it may be further optimized by performing additional rounds of selection starting from a pool of oligonucleotides comprising a plurality of mutagenized aptamer sequences. For use in the present invention, the aptamer may preferably be selected for ligand binding in the presence of salt concentrations and temperatures which mimic normal physiological conditions.

Other features of the invention are described in more details below.

### 2. Switch Design

Switches of the subject invention are nucleic acid molecules, either DNA or RNA or chimeric mixtures, including derivatives or modified versions thereof, either single-stranded or double-stranded, that are designed so that they can “switch,” or adopt at least two conformational states. One of the conformational states is associated with a bound target molecule (ligand-bound or ligand-binding conformation), whereas the other state is not (ligand-free conformation), such that in the presence of the target molecule/ligand, the equilibrium distribution between the two conformational states shifts to favor the ligand-bound or ligand-binding form. This functionality is attained through careful design of the switch's oligonucleotide sequence.

The design of the switch sequences is modular, incorporating distinct domains into the sequence in such a way that they will interact to give switching behavior. For example, in one embodiment, each member in a subject library of aptamer-regulated nucleic acids comprises an aptamer domain and a functional domain that changes conformation upon ligand binding, causing at least one change in one activity of the functional domain. In other embodiments, a subject aptamer-regulated nucleic acid may comprise multiple modular components, e.g., one or more aptamer domains and/or one or more functional domains. The aptamer-regulated nucleic acid platform is flexible, enabling both positive and negative regulation of the activity of the functional domain. Aptamer-regulated nucleic acids may further comprise a functional group or a functional agent, e.g., an intercalator or an alkylating agent.

In general, regardless of the specific identity of the functional domain, the response of the aptamer domain to the ligand may depend on the amount or concentration of ligand exposed to the aptamer domain and/or the ligand identity. For example, an aptamer may bind small molecules, such as drugs, metabolites, intermediates, cofactors, transition state analogs, ions, metals, nucleic acids, and toxins. Alternatively, an aptamer may bind natural and synthetic polymers, including proteins, peptides, nucleic acids, polysaccharides, glycoproteins, hormones, receptors and cell surfaces such as cell walls and cell membranes. In certain other embodiments, the aptamer domain of a ligand controlled nucleic acid is responsive to environmental changes. Environmental changes include, but are not limited to changes in pH, temperature, osmolarity, or salt concentration. The invention thus provides a class of in vitro nucleic acid sensors, for example, aptamer-regulated nucleic acids that sense the presence or amount a molecule in a sample through changes in nucleic acid conformation upon ligand binding to the aptamer domain of an aptamer-regulated nucleic acid.

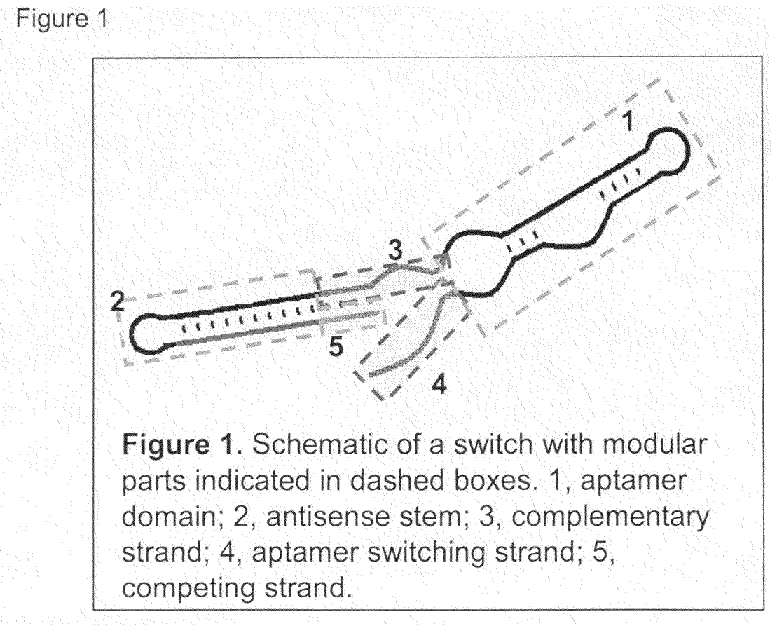

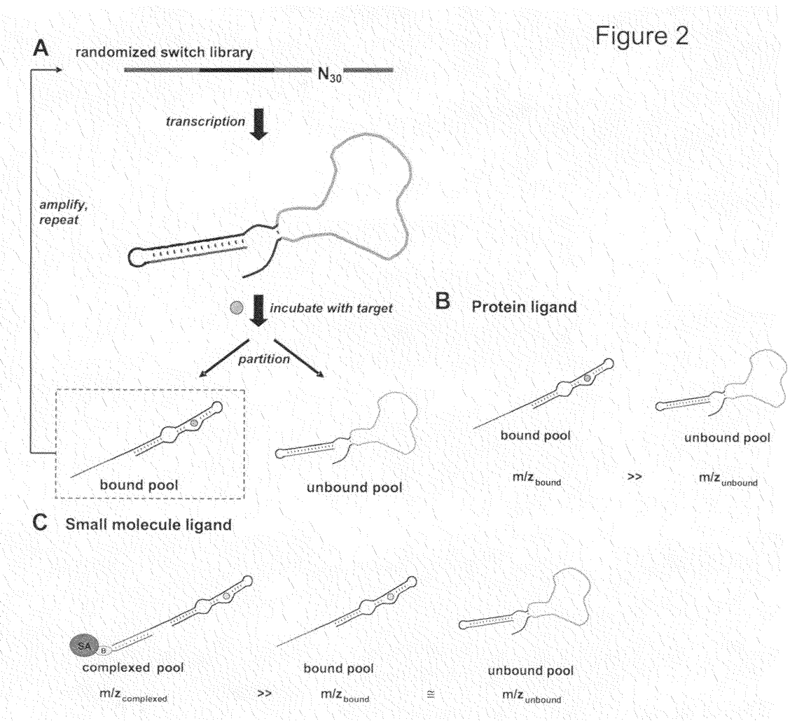

In an exemplary embodiment, a basic switch may have the following parts: an aptamer switching strand, an aptamer (aptamer domain), a complementary strand, an antisense stem, and a competing strand (see a schematic exemplary configuration in FIG. 1).

The aptamer domain encodes the sequence of candidate aptamer for the desired target molecule, which can include previously generated aptamers or new aptamers generated through any number of aptamer selection schemes. More details about the aptamer domain are described further below.

In one design, on the 3′ end of the aptamer domain, the aptamer switching strand is added. On the 5′ end of the aptamer domain, the complementary strand and the antisense stem are added. The 5′ end of the antisense stem is comprised of a competing strand. The aptamer switching strand competes with the competing strand for hybridization to the complementary strand. When the conformational state of the switch is such that the competing strand is bound to the complementary strand, the aptamer domain of the switch cannot bind to the target molecule. When the conformational state of the switch is such that the aptamer switching strand is bound to the complementary strand, the aptamer domain of the switch can bind to the target molecule/ligand. Ligand-binding to the switch will shift the equilibrium distribution between the two states to favor the ligand-bound conformation.

It should be noted that the exemplary switch shown in FIG. 1 is merely one possible configuration. Other configurations are possible based on the designing principle described herein. For example, the aptamer switching strand may be at the 5′ end of the aptamer domain, while the complementary strand and the antisense stem may be added to the 3′ end of the aptamer domain.

In general, the aptamer switching strand can have any sequence, but the selected sequence does not disrupt the folding of the aptamer domain (and encoded ligand-binding pocket) when bound to the complementary strand. This can be verified by, for example, examining the degree of sequence identity between the strands manually, with or without the help of any known sequence comparison software. In certain embodiments, the sequence of the complementary strand is substantially complementary to both the aptamer switching stem and the antisense stem, and is selected to not disrupt the folding of the aptamer domain when bound to the aptamer switching strand.

An “aptamer” may be a nucleic acid molecule, such as RNA or DNA that is capable of binding to a specific molecule with high affinity and specificity (Ellington et al., Nature 346: 818-822, 1990; and Tuerk et al., Science 249: 505-510, 1990). Aptamers have specific binding regions which are capable of forming complexes with an intended target molecule in an environment wherein other substances in the same environment are not complexed to the nucleic acid. The specificity of the binding is defined in terms of the comparative equilibrium dissociation constants (K_{D}) of the aptamer for its ligand as compared to the dissociation constant of the aptamer for other materials in the environment or unrelated molecules in general. A ligand is one which binds to the aptamer with greater affinity than to unrelated material. Typically, the K_{D} for the aptamer with respect to its ligand will be at least about 10-fold less than the K_{D} for the aptamer with unrelated material or accompanying material in the environment. Even more preferably, the K_{D} will be at least about 50-fold less, more preferably at least about 100-fold less, and most preferably at least about 200-fold less. An aptamer will typically be between about 10 and about 300 nucleotides in length. More commonly, an aptamer will be between about 30 and about 100 nucleotides in length.

The terms “nucleic acid molecule” and “polynucleotide” refer to deoxyribonucleotides or ribonucleotides and polymers thereof in either single- or double-stranded form. Unless specifically limited, the term encompasses nucleic acids containing known analogues of natural nucleotides which have similar binding properties as the reference nucleic acid and are metabolized in a manner similar to naturally occurring nucleotides. Unless otherwise indicated, a particular nucleic acid sequence also implicitly encompasses conservatively modified variants thereof (e.g., degenerate codon substitutions) and complementary sequences, as well as the sequence explicitly indicated. Specifically, degenerate codon substitutions may be achieved by generating sequences in which the third position of one or more selected (or all) codons is substituted with mixed-base and/or deoxyinosine residues (Batzer et al., Nucleic Acid Res. 19: 5081, 1991; Ohtsuka et al., J. Biol. Chem. 260: 2605-2608, 1985; and Rossolini et al., Mol. Cell. Probes 8: 91-98, 1994). Also included are molecules having naturally occurring phosphodiester linkages as well as those having non-naturally occurring linkages, e.g., for stabilization purposes. The nucleic acid may be in any physical form, e.g., linear, circular, or supercoiled. The term nucleic acid is used interchangeably with oligonucleotide, gene, cDNA, and mRNA encoded by a gene.

The aptamer-regulated nucleic acid of the invention can be comprised entirely of RNA. In other embodiments of the invention, however, the aptamer-regulated nucleic acid can instead be comprised entirely of DNA, or partially of DNA, or partially of other nucleotide analogs.

In certain embodiments, the sequence of the subject ampliSwitch can be modified as appropriate. For example, the subject aptamer-regulated nucleic acids may comprise synthetic or non-natural nucleotides and analogs (e.g., 6-mercaptopurine, 5-fluorouracil, 5-iodo-2′-deoxyuridine and 6-thioguanine) or may include modified nucleic acids. Exemplary modifications include cytosine exocyclic amines, substitution of 5-bromo-uracil, backbone modifications, methylations, and unusual base-pairing combinations. Aptamer-regulated nucleic acids may include labels, such as fluorescent, radioactive, chemical, or enzymatic labels. Such labels may be present on any nucleotides, such as the end nucleotides.

The subject ampliSwitches can be modified at the base moiety, sugar moiety, or phosphate backbone, for example, to improve stability of the molecule, hybridization, etc. AmpliSwitches may include other appended groups such as peptides. To this end, an ampliSwitch may be conjugated to another molecule, e.g., a peptide.

Aptamer-regulated nucleic acids may be modified so that they are resistant to nucleases, e.g. exonucleases and/or endonucleases, and are therefore stable in solution. Exemplary nucleic acid molecules for use in aptamer-regulated nucleic acids are phosphoramidate, phosphothioate and methylphosphonate analogs of DNA (see also U.S. Pat. Nos. 5,176,996; 5,264,564; and 5,256,775, incorporate by reference).

In certain embodiments, an ampliSwitch may comprise at least one modified base moiety which is selected from the group including but not limited to 5-fluorouracil, 5-bromouracil, 5-chlorouracil, 5-iodouracil, hypoxanthine, xanthine, 4-acetylcytosine, 5-(carboxyhydroxytriethyl) uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil; beta-D-mannosylqueosine, 5-methoxycarboxymethyluracil, 5-methoxyuracil, 2-methylthio-N6-isopentenyladenine, uracil-5-oxyacetic acid (v), wybutoxosine, pseudouracil, queosine, 2-thiocytosine, 5-methyl-2-thiouracil, 2-thiouracil, 4-thiouracil, 5-methyluracil, uracil-5-oxyacetic acid methyl ester, uracil-5-oxyacetic acid (v), 5-methyl-2-thiouracil, 3-(3-amino-3-N-2-carboxypropyl) uracil, (acp3)w, and 2,6-diaminopurine.

An ampliSwitch may also comprise at least one modified sugar moiety selected from the group including but not limited to arabinose, 2-fluoroarabinose, xylulose, xylose, and hexose.

An ampliSwitch can also contain a neutral peptide-like backbone. Such molecules are termed peptide nucleic acid (PNA)-oligomers and are described, e.g., in Perry-O'Keefe et al., Proc. Natl. Acad. Sci. USA 93: 14670, 1996; Eglom et al., Nature 365: 566, 1993. One advantage of PNA oligomers is their capability to bind to complementary DNA essentially independently from the ionic strength of the medium due to the neutral backbone of the PNA. In yet another embodiment, an ampliSwitch comprises at least one modified phosphate backbone selected from the group consisting of a phosphorothioate, a phosphorodithioate, a phosphoramidothioate, a phosphoramidate, a phosphordiamidate, a methylphosphonate, an alkyl phosphotriester, and a formacetal or analog thereof.

Aptamer-regulated nucleic acids of the invention also encompass salts, esters, salts of such esters, or any other salts that are suitable for in vitro use. Suitable base addition salts are formed with metals or amines, such as alkali and alkaline earth metals or organic amines. Examples of metals used as cations are sodium potassium, magnesium, calcium, and the like. Examples of suitable amines are N,NI-dibenzylethylenediamine, chloroprocaine, choline, diethanolamine, dicyclohexylamine, ethylenediamine, N-methylglucamine, and procaine (see, for example, Berge et al., Pharmaceutical Salts, J. of Pharma Sci., 66: 1-19, 1977). The base addition salts of the acidic compounds are prepared by contacting the free acid form with a sufficient amount of the desired base to produce the salt in the conventional manner. The free acid form may be regenerated by contacting the salt form with an acid and isolating the free acid in the conventional manner. The free acid forms differ from their respective salt forms somewhat in certain physical properties such as solubility in polar solvents, but otherwise the salts are equivalent to their respective free acid for purposes of the present invention. As used herein, an addition salt suitable for in vitro use includes a salt of an acid form of one of the components of the compositions of the invention. These include organic or inorganic acid salts of the amines. Preferred acid salts are the hydrochlorides, acetates, salicylates, nitrates and phosphates. Other salts that are suitable for in vitro use are well known to those skilled in the art and include basic salts of a variety of inorganic and organic acids. Preferred examples of acceptable salts include but are not limited to (a) salts formed with cations such as sodium, potassium, ammonium, magnesium, calcium, polyamines such as spermine and spermidine, etc.; (b) acid addition salts formed with inorganic acids, for example hydrochloric acid, hydrobromic acid, sulfuric acid, phosphoric acid, nitric acid and the like; (c) salts formed with organic acids such as, for example, acetic acid, oxalic acid, tartaric acid, succinic acid, maleic acid, fumaric acid, gluconic acid, citric acid, malic acid, ascorbic acid, benzoic acid, tannic acid, palmitic acid, alginic acid, polyglutamic acid, naphthalenesulfonic acid, methanesulfonic acid, p-toluenesulfonic acid, naphthalene disulfonic acid, polygalacturonic acid, and the like; and (d) salts formed from elemental anions such as chlorine, bromine, and iodine.

In a further embodiment, an ampliSwitch is an anomeric oligonucleotide. An anomeric oligonucleotide forms specific double-stranded hybrids with complementary RNA in which, contrary to the usual units, the strands run parallel to each other (Gautier et al., Nucl. Acids Res. 15: 6625-6641, 1987). The oligonucleotide is a 2′-O-methylribonucleotide (Inoue et al., Nucl. Acids Res. 15: 6131-6148, 1987), or a chimeric RNA-DNA analogue (Inoue et al., FEBS Lett. 215: 327-330, 1987).

In certain embodiment, the 5′ end of the aptamer domain includes the competing strand, whose sequence should be able to hybridize with the complementary region. In certain embodiments, a small loop is included in the antisense stem sequence to reduce the strain of nucleic acid folding. In certain embodiments, additional sequences can be added flanking the 5′ and 3′ ends of the basic switch, such as constant regions to facilitate the amplification (such as PCR amplification) of this highly-folded nucleic acid. Care must be taken such that any additions to the switch do not interfere or interact with the parts of the basic switch in such a way that the switching function is impaired. This can be verified with or without the help of any art-recognized sequence comparison software.

One of the main considerations in the design of the switch is to ensure that the sequence of other parts of the switch do not interfere with proper folding of the aptamer domain and the encoded ligand-binding pocket, when the aptamer switching strand is bound to the complementary strand, since this would interfere with binding of the target molecule.

Another consideration is the energetic design of the switch, which affects the equilibrium distribution between the two functional states of the switch and the rates at which it can move between one conformation and the other. In certain embodiments, the switch sequence is designed so that the hybridization of the competing strand with the complementary strand, plus the hybridization within the antisense stem, is more energetically favorable than the hybridization of the aptamer switching strand with the complementary region. This reduces the number of switch molecules in an ensemble that will have their antisense stem open in the absence of target molecules. In certain embodiments, the energetic design allows for some number of switches in an ensemble to be in the conformational state where the aptamer switching stem is hybridized to the complementary strand (ligand-bound form). Ligand binding to this conformation shifts the equilibrium distribution to favor this conformation, resulting in the observed “switching” effect. In certain embodiments, the difference between the energies of the complementary strand hybridizing with the competing strand or the aptamer switching strand (as well as the free energy of the base-pairing antisense stem) can be adjusted or fine tuned through sequence changes to these regions of the molecule in order to adjust the equilibrium distribution between conformations in the absence of ligand and the rates at which the switch is able to move between conformations. In certain embodiments, such sequence changes allow more matching base-paring and/or more stable base-pairing (e.g., G-C vs. A-T or A-U) in one conformation than the other conformation. In certain embodiments, base-modification may also be used to change base-pairing between strands and equilibrium distribution between conformations. In certain embodiments, the energy difference is preferably on the order of 1-10 kcal/mol, but may be more or less depending on specific needs. For example, if it is desirable to increase the binding energy of one hybridization, a base paired A-T pair may be replaced with a base paired G-C pair, or a previously non-base-paired nucleotides can be changed to become an A-T or G-C pair. Additional base pairs may be inserted. The location of the added base pairs may also be adjusted to fine tune the free energy difference. If the opposite is desired, a base paired G-C pair may be replaced with a base paired A-T pair, or a base-paired nucleotide may be changed to eliminating the base-pairing, including deleting the base pair from the sequence.

An aptamer-regulated nucleic acid (ampliSwitch) of the invention may be synthesized by standard methods known in the art, e.g., by use of an automated DNA synthesizer (such as are commercially available from Biosearch, Applied Biosystems, etc.). For example, methods of making aptamers are described in U.S. Pat. No. 5,582,981, PCT Publication No. WO 00/20040, U.S. Pat. No. 5,270,163, Lorsch and Szostak, Biochemistry 33: 973, 1994; Mannironi et al., Biochemistry 36: 9726, 1997; Blind, Proc. Nat'l. Acad. Sci. USA 96: 3606-3610, 1999; Huizenga and Szostak, Biochemistry 34: 656-665, 1995; PCT Publication Nos. WO 99/54506, WO 99/27133, WO 97/42317, and U.S. Pat. No. 5,756,291 (all incorporated by reference). As examples, phosphorothioate oligonucleotides may be synthesized by the method of Stein et al., Nucl. Acids Res. 16: 3209, 1988. Methylphosphonate oligonucleotides can be prepared by use of controlled pore glass polymer supports (Sarin et al., Proc. Natl. Acad. Sci. USA 85: 7448-7451, 1988), etc.

Another approach for generating ampliSwitch nucleic acids utilizes standard recombinant DNA techniques using a construct in which the ampliSwitch or other aptamer-regulated nucleic acid is placed under the control of a strong pol III or pol II promoter in an expression vector. This construct can be transformed or transfected into a prokaryotic or eukaryotic cell that transcribes the ampliSwitch. Such a vector can remain episomal or become chromosomally integrated, as long as it can be transcribed to produce the desired ampliSwitch. Expression vectors appropriate for producing an aptamer-regulated nucleic acid are well-known in the art. For example, the expression vector is selected from an episomal expression vector, an integrative expression vector, and a viral expression vector. A promoter may be operably linked to the sequence encoding the ampliSwitch. Expression of the sequence encoding the ampliSwitch can be by any promoter known in the art to act in eukaryotic or prokaryotic cells. Such promoters can be inducible or constitutive. Examples of mammalian promoters include, but are not limited to the SV40 early promoter region (Bernoist and Chambon, Nature 290: 304-310, 1981), the promoter contained in the 3′ long terminal repeat of Rous sarcoma virus (Yamamoto et al., Cell 22: 787-797, 1980), the herpes thymidine kinase promoter (Wagner et al., Proc. Natl. Acad. Sci. USA 78: 1441-1445, 1981), the regulatory sequences of the metallothionine gene (Brinster et al, Nature 296: 3942, 1982), etc.

In certain embodiments, an aptamer-regulated nucleic acid is in the form of a hairpin or stem-loop structure. Such structures can be synthesized exogenously or can be formed by transcribing from RNA polymerase III promoters in cells suitable for expressing recombinant DNAs. Examples of making and using hairpin structures are described, for example, in Paddison et al., Genes Dev. 16: 948-958, 2002; McCaffrey et al., Nature 418: 38-39, 2002; McManus et al., RNA 8: 842-850, 2002; Yu et al., Proc Natl Acad Sci USA 99: 6047-6052, 2002).

AmpliSwitch nucleic acids can be purified using a number of techniques known to those of skill in the art. For example, gel electrophoresis can be used to purify such molecules. Alternatively, non-denaturing methods, such as non-denaturing column chromatography, can be used to purify the ampliSwitch molecules. In addition, chromatography (e.g., size exclusion chromatography), glycerol gradient centrifugation, and affinity purification with antibodies can be used to purify ampliSwitches.

### 3. Switch Library Design

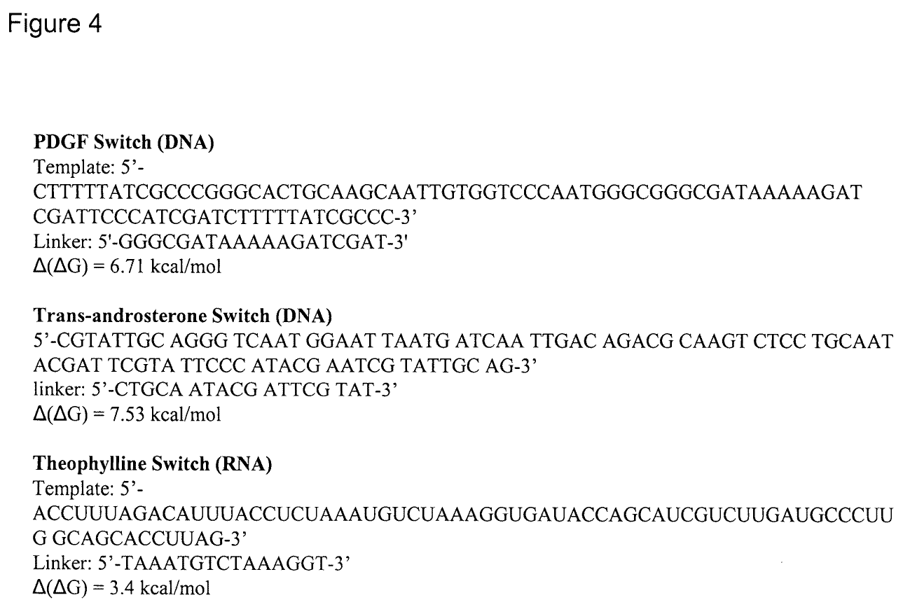

In certain embodiments, a switch library pool is constructed by replacing the aptamer domain of a switch with a region in which the nucleic acid sequence is randomized (FIG. 4). The size and characteristics of this random region can be modified depending on its intended use. In certain embodiments, the switch library pool replaces the aptamer domain of a switch with an N30 region (e.g., a region of a randomized polynucleotide with about 30 nucleotides in length). This allows for the selection of switches harboring new aptamer domains that result in changes in the switch conformation in response to a desired target molecule. In certain other embodiments, it is possible to choose a larger or smaller number of random oligonucleotides to make up this random region. In certain other embodiments, it may be desirable to choose a different configuration of the random region, so as to include a pre-determined stem-loop region for stabilization of the aptamer domain and only randomize the nucleotides on either side of this stem-loop that are responsible for specific switch-target binding interactions. In certain other embodiments, it may be desirable to include a parent aptamer sequence in the aptamer domain and randomize localized regions of this sequence. Although many other variations are possible in the design of the switch library, the regions necessary for switch functionality remain constant.

### 4. DNA Switch Production

The template DNA encoding the subject switch can be synthesized for use in subsequent amplification reactions through any art-recognized means, such as PCR. In certain embodiments, the design of the switch includes constant regions on either end of the switch even if it internally contains a randomized library. These constant regions may be used as priming regions for PCR amplification. In certain embodiments, primers that correspond to these constant priming regions may be synthesized such that the forward primer is labeled by a first label, such as a fluorescein label; and the reverse primer is labeled by a second label, such as a biotin label. PCR amplification using these primers produces a double-stranded DNA version of the single-stranded DNA switch, in which the forward strand is fluorescein labeled and the reverse strand is biotin labeled (or vice versa). The two strands can be separated from each other using, for example, Streptavidin-coated magnetic beads and a magnetic stand from an appropriate manufacturer, used according to the manufacturer's instructions. At the end of this separation procedure, the fluorescein labeled single-stranded switches are isolated while the biotin labeled complementary strands remain bound to the beads.

Any other label may also be used for the above-described amplification-separation scheme. In certain embodiments, the first and second labels are different. In other embodiments, they are same.

In subsequent rounds of selection, this process may be repeated except that the collected fractions from the previous round (e.g., the CE-based separation) serve as the template in the PCR amplification rather than the synthesized template.

### 5. RNA Switch Production

The production of RNA switches may begin in the same way as the production of DNA switches, with PCR amplification from a synthesized template. In certain embodiments, the primers for RNA switch production are not labeled, and the forward primer may include an RNA promoter sequence (such as the T7 promoter sequence) at the 5′ end. The PCR product can be used as template in a (T7) transcription reaction, resulting in single-stranded RNA switches. Once the RNA switches are produced, they can be used directly for use with, for example, the PDA detector, or they can be labeled, for example, fluorescein-labeled, for use with the LIF detector through a 5′ fluorescein labeling reaction.

During subsequent rounds of selection, the RNA switches cannot be amplified directly. Instead, the RNA switch sequences collected from the CE-based separation can first be reverse transcribed to give rise to corresponding cDNA. The process is then repeated using this cDNA as the template in the PCR reaction rather than the synthesized template.

### 6. Exemplary Equilibrium Mixture Preparation

The following is an exemplary protocol for preparing an equilibrium mixture for CE. It should be understood that the procedure is for illustration purpose only, and is by no means limiting in any respect. Minor modifications can be made based on the protocol without departing from the general spirit of the invention.

In certain embodiments, the single-stranded switches are allowed to go through a denaturation-annealing step, such that the switches will denature and then fold into their most energetically favorable conformations during a slow cooling step. For example, the switches may be first heated to about 72-95° C. for 3-10 minutes, and then allowed to cool down to about 25° C. at a rate of about 0.1-0.3° C. per second in an appropriate binding buffer (see below for an exemplary buffer). Once the switches have been renatured, they are combined with their target molecule in an appropriate binding buffer.

The concentration of switch can vary, but is preferably high during the selection process in order to ensure that a substantial number of switches are injected on the CE during separation. In particular, the concentration of the switch pool is highest during the first round of selection and may be between 1-100 μM, or 2-50 μM, or 2.5 μM and 25 μM. The concentration of target molecule in the binding reaction can vary as well, and may be chosen depending on, for example, the kinetic binding properties of the aptamer domain and the rates at which the switch moves between the two conformational states. During the selection procedure, the concentration of the target molecule may be varied during several rounds of selection to adjust the stringency of the selection and to select switches with an affinity for their target molecule within a desired range.

Next, the switch and target molecule are allowed to incubate for 15-60 minutes, depending on known kinetic values, energetic states, etc., in an appropriate buffer, which is preferably chosen based on the following considerations:

1. Providing desired pH ranges (such as using Tris-based buffer);

2. Stabilizing the desired complex, such that the observed dissociation during partitioning of bound and unbound switches is minimized (such as using Glycine);

3. Separating free ligand/complex/unbound switches based on m/z ratios by providing a steady current and maintain pH conditions during partitioning (such as using Tris-Glycine); and/or

4. Facilitating correct folding/binding during the incubation period (such as using MgCl₂).

One suitable buffer is the Tris-Glycine-Potassium (TGK) buffer (Buchanan and Danielle et al., Effect of buffer, electric field, and separation time on detection of aptamer-ligand complexes for affinity probe capillary electrophoresis. Electrophoresis 24: 1375-1382, 2003, incorporated by reference). MgCl₂ can be added to the incubation buffer at appropriate concentrations to assist folding of the nucleic acid molecules. The TGK buffer is 25 mM Tris, 196 mM Glycine and 5 mM K₂HPO₄. Any further dilutions of either the target molecule or switch library before mixing together can be done using the TGK buffer, or other appropriate buffer. The switch-target mixture may be incubated at temperatures between 16-37° C., or 24-37° C. The biotin-labeled oligonucleotide linker is incubated with Streptavidin in the appropriate binding buffer for 15-60 minutes.

Then a linker-Streptavidin complex is added to the equilibrium mixture, and incubation may be continued for another 15-30 minutes. The linker-Streptavidin complex consists of a biotin-labeled “linker” oligonucleotide that is complementary to the 5′ strand of the antisense stem of the switch that has been bound to a Streptavidin protein via its biotin label. During this second incubation step, hybridization occurs between the linker and the free antisense stems of the switches that are in their ligand-bound conformational states, and have likely bound their target molecules. This hybridization occurs preferentially with switches that have bound their target molecules since unbound switches are less likely to have free antisense stems.

The introduction of the linker-Streptavidin complex adds an additional element to the energetics of the switch binding reactions. Hybridization to the linker oligonucleotide energetically stabilizes the ligand-bound conformation of the switch, such that it is possible that unbound switches, which do transiently adopt the ligand-binding conformation at some low frequency, can become stabilized in this conformation due to hybridization to the oligonucleotide linker complex. This event results in a certain amount of “background” binding. In certain embodiments, background binding can be minimized by reducing the linker:switch ratio to an optimal value, which varies based on the particular switch platform being used, but is generally in the range of 1:1 to 1:100. In certain embodiments, background is also reduced by allowing the switch and target molecule to incubate together first before adding the linker-Streptavidin complex.

### 7. CE Methods

Following incubation, the equilibrium mixture containing both bound and unbound switches may be separated using a modified form of either an equilibrium or nonequilibrium CE-based partitioning method. In one embodiment, a nonequilibrium method is used, such that the run buffer during collection does not contain the target ligand.

In a typical CE-based separation method, a 10-20 μL sample of the mixture is placed into a sample vial and a small plug is pressure injected into the capillary, followed by voltage application across the capillary in order to separate the bound and unbound switches. Based on the magnitude of pressure and length of time of the injection, the plug may contain approximately 10¹⁰ to 10¹³ molecules depending on the final concentration of the switch library in the mixture.

Other injection methods, such as electrophoretic/voltage injections, can also be used.

During the voltage application, the bound switch pool and unbound switch pool can be separated and are collected at varying times. For instance, the bound switch pool will typically (but not always, depending for example, on the identity of the ligand) traverse the capillary more quickly and will be collected first based on differences in the m/z ratio of the bound switch complex and the unbound switch. This separation can be accomplished using any art-recognized instruments or methods, such as a Beckman P/ACE MDQ CE instrument with an uncoated fused silica capillary with a 75 micron inner diameter of 40 to 60 cm length.

In one example, using a 60 cm length capillary, the voltage applied across is about 29.5 kV, such that the bound and unbound switch pools are both subjected to an electric field of about 492 V/cm for 12 minutes with a run buffer of 25 mM Sodium Tetraborate at pH 9.3. For any given separation run, a voltage of about 375 V/cm or higher may be used regardless of the capillary length. Additionally, the time required for partitioning the bound and unbound pools can range from 4 to 20 minutes with respect to variations in applied voltage, capillary length and buffer.

Although a constant voltage may be applied, if the run buffer is contaminated or not well mixed/dissolved, the observed current may vary, which will directly affect the migration time of both the bound and unbound switch pools. The separation may be monitored with the laser-induced fluorescence (LIF) module or a PDA module, if the switch is labeled by a suitable fluorescent label. For example, the LIF module can be used to monitor nucleic acid molecules that have been labeled with a fluorescein tag through standard methods (such as PCT amplification). The PDA module may be used to monitor the nucleic acid molecules through absorbance at UV wavelengths, 200 nm, 254-260 nm and 280 nm in parallel/simultaneously. The PDA module can also be used to monitor ligand and buffer components.

In order to determine the collection times, one test run may be observed, and the velocity of the bound switch pool can be calculated based on the length of the capillary from the plug injection to the detection window, which, in certain instruments, is approximately 10 cm less than the total length of the capillary. For example, on a capillary with a total length of 48 cm, the complex peak is detected just after 4 minutes, so the velocity would be 38 centimeters over 4 minutes, or about 9.5 cm/min. Therefore, the collection window can begin at about 5 minutes, as it will take approximately another minute until the bound complex is at the end of the capillary.

In addition to determining the initial collection time, the end collection time for the bound switch pool ends may be based on the time of LIF (or other module) detection of the unbound peak. The collection time for the bound switch pool may be set to end one minute following the detection of the unbound peak based on the above calculated velocity. This example can be tailored given any capillary length, applied voltage, and switch-target mixture. However, should a bound switch complex peak not be detected, the collection time may be set to collect for 4 to 5 minutes before the observed unbound peak would elute based on the velocity calculated for the front end of the unbound peak. In other words, collection may begin at about 4-5 min before the unbound peak would elute, and collection may end right before the unbound peak would elute. If the time of elution for the free target is known, then collection of the bound switch pool should begin after this time as well.

The collected pools may then be amplified through standard methods. For example, DNA pools may be amplified through polymerase chain reaction (PCR) of the collected sample with appropriate primer pairs. RNA pools may be amplified through reverse transcriptase-PCR (RT-PCR) of the collected sample with appropriate primer pairs. Buffers used for RNA pools must be RNase-Free as treated through standard methods such as DEPC-treatment.

The amplification samples may be purified, including removing target molecules from the collected pools or amplification product prior to subsequent selection rounds.

Results show that amplification of the collected sample can be achieved after only one collection run. However, multiple runs can be collected from a mixture in order to increase the number and diversity of the members of the collected pool as appropriate. In certain embodiments, it may be advantageous, in the earlier selection rounds in the CE-SELEX process, to use higher numbers of consecutive collection runs to obtain significantly more binders for subsequent rounds.

### 8. Functional Domains

Numerous functional domains may be used in the subject ampliSwitch. Regardless of the specific activity of the functional domains, ligand binding at the aptamer domain mediates a change in the conformational dynamics of the ampliSwitch, causing at least one activity change in the functional domain. The following describes merely a few non-limiting examples of functional domains that may be used in the subject ampliSwitch library.

(i) Primer Sequences as Functional Domains

In certain embodiments, the functional domain comprises a primer sequence, such that ligand binding at the aptamer domain mediates a change in the conformational dynamics of these molecules that allows the primer sequence to hybridize to a target nucleic acid template. In certain embodiments, the primer sequence domain of a subject aptamer-regulated nucleic acid interacts with a target template nucleic acid by nucleic acid hybridization. For instance, an aptamer-regulated nucleic acid may comprise a primer sequence domain that comprises a hybridization sequence that hybridizes to a target template and an aptamer domain that binds to a ligand. The binding of the ligand to the aptamer domain favors a conformational change in the aptamer-regulated nucleic acid that alters the ability (such as availability and/or Tₘ) of the hybridization sequence of the primer domain to hybridize to a target template.

Thus in this embodiment, an aptamer domain responds to ligand or analyte binding to induce an allosteric change in the priming sequence domain, and alters the ability of the priming sequence domain to interact with its target template. Ligand binding, therefore, switches the primer domain from “off” to “on,” or vice versa. Aptamer-regulated nucleic acids, therefore, act as a switch whose activity is turned “off” and “on” in response to ligand binding. In other words, a ligand that interacts with the aptamer domain of an aptamer-regulated nucleic acid switches “on” the primer domain of the aptamer-regulated nucleic acid. The activated primer domain then hybridizes to a target template to form a primer:template pair. Alternatively, in the reverse scenario, ligand binding causes the previously available/high affinity primer to become unavailable or have low affinity for the target sequence.

In certain embodiments, the primer:template pair may act as a substrate for an extrinsic enzymatic activity. For example, the primer:template pair may act as a substrate for a DNA polymerase (e.g., taq polymerase or phi29 polymerase) which extends the primer sequence to form a complementary nucleic acid extension product. The presence and amount of the extension product, therefore, correlates with the amount or concentration of the ligand of interest.

Extension of the primer sequence in a primer:template pair may be performed by any polymerase-mediated primer extension reaction and/or any nucleic acid amplification techniques. For instance, primer extension may be performed by PCR (including QC-PCR, arbitrarily primed PCR, immuno-PCR, Alu-PCR, PCR single strand conformational polymorphism, allelic PCR, RT-PCR, quantitative real-time PCR, biotin capture PCR, vectorette PCR, panhandle PCR, PCR select cDNA subtraction), strand displacement assay (SDA), rolling circle amplification (RCA), cycling probe technology (CPT), transcription mediated amplification (TMA), nucleic acid sequence based amplification (NASBA), Ligase chain reaction (LCR), invasive cleavage (e.g., Invader™) technology, or other amplification methods known in the art. Natural, non-natural or modified nucleotides may be incorporated into the extension products. Non-natural or modified nucleotides include, without limitation, radioactively, fluorescently, or chemically-labeled nucleotides. Furthermore, extension products may comprise one or more fluorophores and/or quencher moieties which alter the fluorescence of the sample. A quencher moiety causes there to be little or no signal from a fluorescent label (e.g., a fluorophore) when placed in proximity to the label. Such methods are useful, for example, in rapid or high-throughput methods. Detection of a labeled extension product may be performed by direct or indirect means (e.g., via a biotin/Avidin or a biotin/Streptavidin linkage, agarose gel-based methods, fluorescent detection, or sequence specific hybridization on an oligonucleotide microarray or nitrocellulose filter). It is not intended that the present invention be limited to any particular detection system or label.

Any method known in the art can be used to detect the extension product. For example, an extension product can be detected by colorimetric detection, fluorescent detection, chemiluminescence, gel electrophoresis, or oligonucleotide microarray. In certain embodiments, the extension product is comprised of one or more non-natural or modified nucleotides. Non-natural or modified nucleotides include, without limitation, radioactively, fluorescently, or chemically labeled nucleotides. In other embodiments, the extension product is labeled with one or more fluorophores and/or quenchers which alter the fluorescence of the sample.

According to this embodiment of the invention, a primer sequence may be a nucleic acid molecule, such as DNA or RNA, that is capable of hybridizing to a specific target nucleic acid template with high affinity and specificity. The primer sequence has a specific binding region that is capable of forming complexes with an intended target template molecule in an environment wherein other substances in the same environment are not complexed to the nucleic acid. The specificity of the binding may be defined in terms of the comparative melting point of the primer sequence for its target template as compared to the melting point of the priming sequence for other unrelated nucleic acids in the environment. A target template will bind to the primer sequence with greater affinity than to unrelated material.

Hybridization of the primer sequence to the target template may be by conventional base pair complementarity. The ability to hybridize will depend on the degree of complementarity between the primer sequence and the target template. Generally, the longer the hybridizing portion of the primer sequence, the more base mismatches with a target nucleic acid it may contain and still form a stable duplex (or triplex, as the case may be). One skilled in the art can ascertain a tolerable degree of mismatch by use of standard procedures to determine the melting point of the hybridized complex. The melting point of the hybridized complex is determined according to the hybridization conditions in the assay that will be used.

In certain embodiments, the length of the primer sequence of an aptamer-regulated nucleic acid is between about 8 and about 500 nucleotides. In other embodiments, the length of the primer sequence is between about 10 and about 250, about 20 and about 150 nucleotides, or about 20 and about 100 nucleotides. The length of the primer sequence that is complementary to the target template may be all or a portion of the primer sequence domain. For example, the length of a primer sequence that is complementary to a target template may be between about 4 and about 500 nucleotides. In other embodiments, the length of a primer sequence that is complementary to a target template is between about 10 and about 250, about 12 and about 150 nucleotides, or about 12 and about 100 nucleotides.

Under stringent conditions, a primer sequence in an ampliSwitch will hybridize to its target template, but not to an unrelated nucleic acid. Nucleic acid hybridization is affected by such conditions as salt concentration, temperature, organic solvents, base composition, length of the complementary strands, and the number of nucleotide base mismatches between the hybridizing nucleic acids. A variety of hybridization conditions may be used in the present invention, including high, moderate and low stringency conditions; see for example Maniatis et al., Molecular Cloning: A Laboratory Manual, 2nd Edition, 1989, and Short Protocols in Molecular Biology, ed. Ausubel, et al, hereby incorporated by reference. Stringent conditions are sequence-dependent and will be different in different circumstances. Longer complementary sequences hybridize specifically at higher temperatures. An extensive guide to the hybridization of nucleic acids is found in Tijssen, Techniques in Biochemistry and Molecular Biology—Hybridization with Nucleic Acid Probes, “Overview of principles of hybridization and the strategy of nucleic acid assays” (1993). Generally, stringent conditions are selected to be about 5-10° C. lower than the thermal melting point (Tₘ) for the specific sequence at a defined ionic strength and pH. Stringent conditions will be those in which the salt concentration is less than about 1.0 M sodium ion, typically about 0.01 to 1.0 M sodium ion concentration (or other salts) at pH 7.0 to 8.3 and the temperature is at least about 30° C. to about 60° C. Stringent conditions may also be achieved with the addition of helix destabilizing agents such as formamide. The hybridization conditions may also vary when a non-ionic backbone, i.e., PNA is used, as is known in the art. In addition, cross-linking agents may be added to covalently attach a primer:template pair. These parameters may also be used to control non-specific binding, as is generally outlined in U.S. Pat. No. 5,681,697. Thus it may be desirable to perform certain steps at higher stringency conditions to reduce non-specific binding.

Sequence identity between the primer sequence and target template may be optimized by sequence comparison and alignment algorithms known in the art (see Gribskov and Devereux, Sequence Analysis Primer, Stockton Press, 1991, and references cited therein) and calculating the percent difference between the nucleotide sequences by, for example, the Smith-Waterman algorithm as implemented in the BESTFIT software program using default parameters (e.g., University of Wisconsin Genetic Computing Group). Greater than 90% sequence identity, or even 100% sequence identity, between the primer sequence and the target template is preferred.

A target template may be engineered or it may be a portion of a gene, a regulatory sequence, genomic DNA, cDNA, RNA including mRNA and rRNA, or others. As is outlined herein, the target template may be a target sequence from a sample, or a secondary target such as a product of a reaction. The selection of a target template sequence is dependent on factors such as desired length, complementarity to the primer sequence, and desired length and sequence of the extension product produced upon primer extension of the primer sequence. The target template sequence may also depend on the method used to detect the extension product in a primer extension reaction that uses the primer:template pair as a substrate. The skilled artisan will evaluate these considerations to select the appropriate target template. For instance, the desired length of the extension product may be from about 5 nucleotides to about 5000 nucleotides, from about 10 nucleotides to about 3000 nucleotides, from about 20 nucleotides to about 1500 nucleotides, from about 25 nucleotides to about 750 nucleotides or from about 100 to about 500 nucleotides. Accordingly, the desired length of the target template will correspond to the desired length of the extension product, and therefore, be in a similar range, or about 5, 10, 25, 50, 100, 250, 500, 1000, 1500, 2500, or 5000 nucleotides long. The sequence of the target template can be tailored according to the method used to detect the extension product. For example, if methods such as size, fluorescence, radioactivity, or luminescence are used to detect the extension product, the sequence of the target template may not be critical. However, the sequence of the extension product, and therefore the target template, may be important when sequence specific hybridization of the extension product is used. For example, the extension product may be applied to a nucleic acid microarray or to nucleic acids spotted on a nitrocellulose filter. These detection methods depend on sequence specific hybridization to identify the extension product of interest. In instances where the extension product is detected by agarose-gel based electrophoresis, the exact sequence of the extension product, and therefore the target template, may not be critical, but the length of the product may be important to detecting the extension product.

A nucleic acid target template used in the invention may be synthesized by standard methods known in the art, e.g., by use of an automated DNA synthesizer. A target template may also be generated using standard recombinant DNA methods as described herein. Primer sequences and target templates refer to deoxyribonucleotides or ribonucleotides and polymers thereof in either single- or double-stranded form. Unless specifically limited, they encompass nucleic acids containing known analogues of natural nucleotides which have similar binding properties as the reference nucleic acid and are metabolized in a manner similar to naturally occurring nucleotides. Unless otherwise indicated, a particular nucleic acid sequence also implicitly encompasses conservatively modified variants thereof (e.g., degenerate codon substitutions) and complementary sequences, as well as the sequence explicitly indicated. Specifically, degenerate codon substitutions may be achieved by generating sequences in which the third position of one or more selected (or all) codons is substituted with mixed-base and/or deoxyinosine residues (Batzer et al., Nucleic Acid Res. 19: 5081, 1991; Ohtsuka et al., J. Biol. Chem. 260: 2605-2608, 1985; and Rossolini et al., Mol. Cell. Probes 8: 91-98, 1994). Also included are molecules having naturally occurring phosphodiester linkages as well as those having non-naturally occurring linkages, e.g., for stabilization purposes. The nucleic acid may be in any physical form, e.g., linear, circular, or supercoiled. The term nucleic acid is used interchangeably with oligonucleotide, gene, cDNA, and mRNA encoded by a gene.

If required, the sample and target template are prepared using known techniques. For example, the sample may be treated to lyse cells in a sample, using known lysis buffers, sonication, electroporation, etc., with purification occurring as needed, as will be appreciated by those in the art. In addition, the reactions outlined herein may be accomplished in a variety of ways, as will be appreciated by those in the art. Components of the reaction may be added simultaneously, or sequentially, in any order. In addition, the reaction may include a variety of other reagents which may be included in the assays. These include reagents such as salts, buffers, neutral proteins, e.g. albumin, detergents, etc., which may be used to facilitate optimal hybridization and detection, and/or reduce non-specific or background interactions. Also reagents that otherwise improve the efficiency of the assay, such as protease inhibitors, nuclease inhibitors, anti-microbial agents, etc., may be used, depending on the sample preparation methods and purity of the target.

Once the primer:template pair has formed, an enzyme, such as a primer extension enzyme (e.g., DNA polymerase, ligase, etc.) or a Dicer-like RNase III, is used to synthesize an extension product or to cleave the primer:template pair, respectively. As for all the methods outlined herein, the enzymes may be added at any point during the assay. The identity of the enzyme will depend on the primer extension technique used, as is more fully outlined below.

(ii) Antisense Sequences as Effector Domains

An aptamer-regulated nucleic acid may comprise an effector domain as the subject functional domain, which effector domain may comprise an antisense sequence and acts through an antisense mechanism for inhibiting expression of a target gene (“antiswitch”). Antisense technologies have been widely utilized to regulate gene expression (Buskirk et al., Chem Biol 11: 1157-1163, 2004; and Weiss et al., Cell Mol Life Sci 55: 334-358, 1999). As used herein, “antisense” technology refers to administration or in situ generation of molecules or their derivatives which specifically hybridize (e.g., bind) under cellular conditions, with the target nucleic acid of interest (mRNA and/or genomic DNA) encoding one or more of the target proteins so as to inhibit expression of that protein, e.g., by inhibiting transcription and/or translation, such as by steric hinderance, altering splicing, or inducing cleavage or other enzymatic inactivation of the transcript. The binding may be by conventional base pair complementarity, or, for example, in the case of binding to DNA duplexes, through specific interactions in the major groove of the double helix. In general, “antisense” technology refers to the range of techniques generally employed in the art, and includes any therapy that relies on specific binding to nucleic acid sequences.

An aptamer-regulated nucleic acid that comprises an antisense effector domain of the present invention can be delivered, for example, as a component of an expression plasmid which, when transcribed in the cell, produces an effector domain which is complementary to at least a unique portion of the target nucleic acid. Alternatively, the aptamer-regulated nucleic acid that comprises an antisense effector domain can be generated outside of the target cell, and which, when introduced into the target cell causes inhibition of expression by hybridizing with the target nucleic acid. Aptamer-regulated nucleic acids may be modified so that they are resistant to endogenous nucleases, e.g., exonucleases and/or endonucleases, and are therefore stable in vivo. Exemplary nucleic acid molecules for use in aptamer-regulated nucleic acids are phosphoramidate, phosphothioate and methylphosphonate analogs of DNA (see also U.S. Pat. Nos. 5,176,996; 5,264,564; and 5,256,775). General approaches to constructing oligomers useful in antisense technology have been reviewed, for example, by van der Krol et al., Biotechniques 6: 958-976, 1988; and Stein et al., Cancer Res 48: 2659-2668, 1988.

Several considerations may be taken into account when constructing antisense effector domains for use in the compositions and methods of the invention: (1) antisense effector domains may preferably have a GC content of 50% or more; (2) avoid sequences with stretches of 3 or more Gs; and (3) antisense effector domains may not be longer than 25-26 mers when in their “on” state and modulating a target gene. When testing an antisense effector domain, a mismatched control can be constructed. The controls can be generated by reversing the sequence order of the corresponding antisense oligonucleotide in order to conserve the same ratio of bases.

Antisense approaches involve the design of effector domains (either DNA or RNA) that are complementary to a target nucleic acid encoding a protein of interest. The antisense effector domain may bind to an mRNA transcript and prevent translation of a protein of interest. Absolute complementarity, although preferred, is not required. In the case of double-stranded antisense effector domains, a single strand of the duplex DNA may thus be tested, or triplex formation may be assayed. The ability to hybridize will depend on both the degree of complementarity and the length of the antisense sequence. Generally, the longer the hybridizing nucleic acid, the more base mismatches with a target nucleic acid it may contain and still form a stable duplex (or triplex, as the case may be). One skilled in the art can ascertain a tolerable degree of mismatch by use of standard procedures to determine the melting point of the hybridized complex.

Antisense effector domains that are complementary to the 5′ end of an mRNA target, e.g., the 5′ untranslated sequence up to and including the AUG initiation codon, should work most efficiently at inhibiting translation of the mRNA. However, sequences complementary to the 3′ untranslated sequences of mRNAs have recently been shown to be effective at inhibiting translation of mRNAs as well (Wagner, Nature 372: 333, 1994). Therefore, antisense effector domains complementary to either the 5′ or 3′ untranslated, non-coding regions of a target gene could be used in an antisense approach to inhibit translation of a target mRNA. Antisense effector domains complementary to the 5′ untranslated region of an mRNA should include the complement of the AUG start codon. Antisense oligonucleotides complementary to mRNA coding regions are less efficient inhibitors of translation but could also be used in accordance with the invention. Whether designed to hybridize to the 5′, 3′, or coding region of mRNA, antisense nucleic acids should be at least six nucleotides in length, and are preferably less that about 100 and more preferably less than about 50, 25, 17 or 10 nucleotides in length.

Regardless of the choice of target sequence, it is preferred that in vitro studies are first performed to quantitate the ability of the antiswitch to inhibit expression of a target gene. It is preferred that these studies utilize controls that distinguish between antisense gene inhibition and nonspecific biological effects of antiswitches. It is also preferred that these studies compare levels of the target RNA or protein with that of an internal control RNA or protein. Additionally, it is envisioned that results obtained using the antiswitch are compared with those obtained using a control antiswitch. It is preferred that the control antiswitch is of approximately the same length as the test antiswitch and that the nucleotide sequence of the control antiswitch differs from the antisense sequence of interest no more than is necessary to prevent specific hybridization to the target sequence.

As described herein, antiswitches can be DNA or RNA or chimeric mixtures or derivatives or modified versions thereof, single-stranded or double-stranded. Antiswitches can be modified at the base moiety, sugar moiety, or phosphate backbone, for example, to improve stability of the molecule, hybridization, etc. Antiswitches may include other appended groups such as peptides (e.g., for targeting host cell receptors), or agents facilitating transport across the cell membrane (see, e.g., Letsinger et al., Proc Natl Acad. Sci. USA 86: 6553-6556, 1989; Lemaitre et al., Proc Natl Acad. Sci. USA 84: 648-652, 1987; PCT Publication No. WO88/0981 0) or the blood-brain barrier (see, e.g., PCT Publication No. WO89/10134), hybridization-triggered cleavage agents. (See, e.g., Krol et al., BioTechniques 6: 958-976, 1988) or intercalating agents. (See, e.g., Zon, Pharm. Res. 5: 539-549, 1988). To this end, an antiswitch may be conjugated to another molecule, e.g., a peptide, hybridization triggered cross-linking agent, transport agent, hybridization-triggered cleavage agent, etc.

An antiswitch may comprise at least one modified base moiety which is selected from the group including but not limited to 5-fluorouracil, 5-bromouracil, 5-chlorouracil, 5-iodouracil, hypoxanthine, xanthine, 4-acetylcytosine, 5-(carboxyhydroxytriethyl) uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil; beta-D-mannosylqueosine, 5-methoxycarboxymethyluracil, 5-methoxyuracil, 2-methylthio-N-6-isopentenyladenine, uracil-5-oxyacetic acid (v), wybutoxosine, pseudouracil, queosine, 2-thiocytosine, 5-methyl-2-thiouracil, 2-thiouracil, 4-thiouracil, 5-methyluracil, uracil-5-oxyacetic acid methyl ester, uracil-5-oxyacetic acid (v), 5-methyl-2-thiouracil, 3-(3-amino-3-N-2-carboxypropyl) uracil, (acp3)w, and 2,6-diaminopurine.

An antiswitch may also comprise at least one modified sugar moiety selected from the group including but not limited to arabinose, 2-fluoroarabinose, xylulose, xylose, and hexose.

An antiswitch can also contain a neutral peptide-like backbone. Such molecules are termed peptide nucleic acid (PNA)-oligomers and are described, e.g., in Perry-O'Keefe et al. Proc. Natl. Acad. Sci. USA 93: 14670, 1996; and in Eglom et al., Nature 365: 566, 1993. One advantage of PNA oligomers is their capability to bind to complementary DNA essentially independently from the ionic strength of the medium due to the neutral backbone of the DNA. In yet another embodiment, an antiswitch comprises at least one modified phosphate backbone selected from the group consisting of a phosphorothioate, a phosphorodithioate, a phosphoramidothioate, a phosphoramidate, a phosphordiamidate, a methylphosphonate, an alkyl phosphotriester, and a formacetal or analog thereof.

In a further embodiment, an antiswitch is an anomeric oligonucleotide. An anomeric oligonucleotide forms specific double-stranded hybrids with complementary RNA in which, contrary to the usual units, the strands run parallel to each other (Gautier et al., Nucl. Acids Res. 15: 6625-6641, 1987). The oligonucleotide is a 2′-O-methylribonucleotide (Inoue et al., Nucl. Acids Res. 15: 6131-6148, 1987), or a chimeric RNA-DNA analogue (Inoue et al., FEBS Lett. 215: 327-330, 1987).

Aptamer-regulated nucleic acids of the invention, including antiswitches, may be synthesized by standard methods known in the art, e.g., by use of an automated DNA synthesizer (such as are commercially available from Biosearch, Applied Biosystems, etc.). As examples, phosphorothioate oligonucleotides may be synthesized by the method of Stein et al. Nucl. Acids Res. 16: 3209, 1988; methylphosphonate oligonucleotides can be prepared by use of controlled pore glass polymer supports (Sarin et al., Proc. Natl. Acad. Sci. USA 85: 7448-7451, 1988), etc.

While antisense sequences complementary to the coding region of an mRNA sequence can be used, those complementary to the transcribed untranslated region and to the region comprising the initiating methionine are most preferred.

Antiswitch nucleic acid molecules can be delivered to cells that express target genes in vivo. A number of methods have been developed for delivering nucleic acids into cells; e.g., they can be injected directly into the tissue site, or modified nucleic acids, designed to target the desired cells (e.g., antiswitches linked to peptides or antibodies that specifically bind receptors or antigens expressed on the target cell surface) can be administered systematically.

However, it may be difficult to achieve intracellular concentrations of the antiswitch sufficient to attenuate the activity of a target gene or mRNA or interest in certain instances. Therefore, another approach utilizes a recombinant DNA construct in which the antiswitch or other aptamer-regulated nucleic acid is placed under the control of a strong pol III or pol II promoter. The use of such a construct to transfect target cells in the patient will result in the transcription of sufficient amounts of antiswitches that will form complementary base pairs with the target gene or mRNA and thereby attenuate the activity of the protein of interest. For example, a vector can be introduced in vivo such that it is taken up by a cell and directs the transcription of an antiswitch. Such a vector can remain episomal or become chromosomally integrated, as long as it can be transcribed to produce the desired antiswitch. Such vectors can be constructed by recombinant DNA technology methods standard in the art. Vectors can be plasmid, viral, or others known in the art, used for replication and expression in desired cells, such as bacterial, yeast, insect, or mammalian cells. A promoter may be operably linked to the sequence encoding the antiswitch. Expression of the sequence encoding the antiswitch can be by any promoter known in the art, such as those known to act in bacteria, yeasts, mammalian cells, preferably human cells, etc. Such promoters can be inducible or constitutive. Such promoters include but are not limited to: the SV40 early promoter region (Bernoist and Chambon, Nature 290: 304-310, 1981), the promoter contained in the 3′ long terminal repeat of Rous sarcoma virus (Yamamoto et al., Cell 22: 787-797, 1980), the herpes thymidine kinase promoter (Wagner et al., Proc. Natl. Acad. Sci. USA 78: 1441-1445, 1981), the regulatory sequences of the metallothionine gene (Brinster et al, Nature 296: 3942, 1982), etc. Any type of plasmid, cosmid, YAC or viral vector can be used to prepare the recombinant DNA construct that can be introduced directly into the tissue site. Alternatively, viral vectors can be used which selectively infect the desired tissue, in which case administration may be accomplished by another route (e.g., systematically).

(iii) RNAi Sequences as Effector Domains

In some embodiments, the functional domain of the subject aptamer-regulated nucleic acid comprises an effector domain that comprises an RNAi sequence and acts through an RNAi or miRNA mechanism in modulating expression of a target gene. For instance, an aptamer-regulated nucleic acid may comprise an effector domain that comprises a miRNA or siRNA sequence for inhibiting expression of a target gene and an aptamer domain that binds to a ligand. The binding of the ligand to the aptamer domain favors a conformational change in the aptamer-regulated nucleic acid that alters the ability of the miRNA or siRNA sequence of the effector domain to inhibit expression of the target sequence. For example, in one conformation, the miRNA or siRNA sequence may be a substrate for a Dicer-like RNase III enzyme, such that active miRNA or siRNA can be generated in the presence of Dicer. In another conformation, the functional/effector domain is not a Dicer substrate so that no miRNA or siRNA sequence may be generated under the same condition.

In one embodiment, an effector domain comprises a miRNA or siRNA sequence that is between about 19 nucleotides and about 35 nucleotides in length, or preferably between about 25 nucleotides and about 35 nucleotides. In certain embodiments, the effector domain is a hairpin loop that may be processed by RNase enzymes (e.g., Drosha and Dicer). As used herein, the term “RNAi” means an RNA-mediated mechanism for attenuating gene expression and includes small RNA-mediated silencing mechanisms. RNA-mediated silencing mechanisms include inhibition of mRNA translation and directed cleavage of targeted mRNAs. Recent evidence has suggested that certain RNAi constructs may also act through chromosomal silencing, i.e., at the genomic level, rather than, or in addition to, the mRNA level. Thus, the sequence targeted by the effector domain can also be selected from untranscribed sequences that regulate transcription of a target gene of the genomic level.

An RNAi construct contains a nucleotide sequence that hybridizes under physiologic conditions of the cell to the nucleotide sequence of at least a portion of the mRNA transcript for the gene to be inhibited (i.e., the “target” gene). The double-stranded RNA need only be sufficiently similar to natural RNA such that it has the ability to mediate RNAi. Thus, the invention has the advantage of being able to tolerate sequence variations that might be expected due to genetic mutation, strain polymorphism or evolutionary divergence. The number of tolerated nucleotide mismatches between the target sequence and the RNAi construct sequence is no more than 1 in 5 basepairs, or 1 in 10 basepairs, or 1 in 20 basepairs, or 1 in 50 basepairs. Mismatches in the center of the siRNA duplex are most critical and may essentially abolish cleavage of the target RNA. In contrast, nucleotides at the 3′ end of the siRNA strand that is complementary to the target RNA do not significantly contribute to specificity of the target recognition.

Sequence identity may be optimized by sequence comparison and alignment algorithms known in the art (see Gribskov and Devereux, Sequence Analysis Primer, Stockton Press, 1991, and references cited therein) and calculating the percent difference between the nucleotide sequences by, for example, the Smith-Waterman algorithm as implemented in the BESTFIT software program using default parameters (e.g., University of Wisconsin Genetic Computing Group). Greater than 90% sequence identity, or even 100% sequence identity, between the inhibitory RNA and the portion of the target gene is preferred. Alternatively, the duplex region of the RNA may be defined functionally as a nucleotide sequence that is capable of hybridizing with a portion of the target gene transcript (e.g., 400 mM NaCl, 40 mM PIPES pH 6.4, 1 mM EDTA, 50° C. or 70° C. hybridization for 12-16 hours; followed by washing).

Production of aptamer-regulated nucleic acids that comprise an effector domain comprising RNAi sequences can be carried out by any of the methods for producing aptamer-regulated nucleic acids described herein. For example, an aptamer-regulated nucleic acid can be produced by chemical synthetic methods or by recombinant nucleic acid techniques. Endogenous RNA polymerase of the treated cell may mediate transcription in vivo, or cloned RNA polymerase can be used for transcription in vitro. Aptamer-regulated nucleic acids, including antiswitches or those that modulate target gene activity by RNAi mechanisms may include modifications to either the phosphate-sugar backbone or the nucleoside, e.g., to reduce susceptibility to cellular nucleases, improve bioavailability, improve formulation characteristics, and/or change other pharmacokinetic properties. For example, the phosphodiester linkages of natural RNA may be modified to include at least one nitrogen or sulfur heteroatom. Modifications in RNA structure may be tailored to allow specific genetic inhibition while avoiding a general response to dsRNA. Likewise, bases may be modified to block the activity of adenosine deaminase. Aptamer-regulated nucleic acids may be produced enzymatically or by partial/total organic synthesis, any modified ribonucleotide can be introduced by in vitro enzymatic or organic synthesis.

Methods of chemically modifying RNA molecules can be adapted for modifying RNAi constructs (see, for example, Heidenreich et al., Nucleic Acids Res. 25: 776-780, 1997; Wilson et al., J Mol Recog 7: 89-98, 1994; Chen et al., Nucleic Acids Res 23: 2661-2668, 1995; Hirschbein et al., Antisense Nucleic Acid Drug Dev 7: 55-61, 1997). Merely to illustrate, the backbone of an RNAi construct can be modified with phosphorothioates, phosphoramidate, phosphodithioates, chimeric methylphosphonate-phosphodiesters, peptide nucleic acids, 5-propynyl-pyrimidine containing oligomers or sugar modifications (e.g., 2′-substituted ribonucleosides, a-configuration).

The double-stranded structure may be formed by a single self-complementary RNA strand or two complementary RNA strands. RNA duplex formation may be initiated either inside or outside the cell. The RNA may be introduced in an amount which allows delivery of at least one copy per cell. Higher doses (e.g., at least 5, 10, 100, 500 or 1000 copies per cell) of double-stranded material may yield more effective inhibition, while lower doses may also be useful for specific applications. Inhibition is sequence-specific in that nucleotide sequences corresponding to the duplex region of the RNA are targeted for genetic inhibition.

In certain embodiments, the subject RNAi constructs are “siRNAs.” These nucleic acids are between about 19-35 nucleotides in length, and even more preferably 21-23 nucleotides in length, e.g., corresponding in length to the fragments generated by nuclease “dicing” of longer double-stranded RNAs. The siRNAs are understood to recruit nuclease complexes and guide the complexes to the target mRNA by pairing to the specific sequences. As a result, the target mRNA is degraded by the nucleases in the protein complex or translation is inhibited. In a particular embodiment, the 21-23 nucleotide siRNA molecules comprise a 3′ hydroxyl group.

In other embodiments, the subject RNAi constructs are “miRNAs.” microRNAs (miRNAs) are small non-coding RNAs that direct post-transcriptional regulation of gene expression through interaction with homologous mRNAs. miRNAs control the expression of genes by binding to complementary sites in target mRNAs from protein coding genes. miRNAs are similar to siRNAs. miRNAs are processed by nucleolytic cleavage from larger double-stranded precursor molecules. These precursor molecules are often hairpin structures of about 70 nucleotides in length, with 25 or more nucleotides that are base-paired in the hairpin. The RNase III-like enzymes Drosha and Dicer (which may also be used in siRNA processing) cleave the miRNA precursor to produce an miRNA. The processed miRNA is single-stranded and incorporates into a protein complex, termed RISC or miRNP. This RNA-protein complex targets a complementary mRNA. miRNAs inhibit translation or direct cleavage of target mRNAs (Brennecke et al., Genome Biology 4: 228, 2003; Kim et al., Mol. Cells 19: 1-15, 2005).

In certain embodiments, miRNA and siRNA constructs can be generated by processing of longer double-stranded RNAs, for example, in the presence of the enzymes Dicer or Drosha. Dicer and Drosha are RNAse III-like nucleases that specifically cleave dsRNA. Dicer has a distinctive structure which includes a helicase domain and dual RNAse III motifs. Dicer also contains a region of homology to the RDE1/QDE2/ARGONAUTE family, which have been genetically linked to RNAi in lower eukaryotes. Indeed, activation of, or overexpression of Dicer may be sufficient in many cases to permit RNA interference in otherwise non-receptive cells, such as cultured eukaryotic cells, or mammalian (non-oocytic) cells in culture or in whole organisms. Methods and compositions employing Dicer, as well as other RNAi enzymes, are described in U.S. Pat. App. Publication No. 20040086884.

In one embodiment, the Drosophila in vitro system is used. In this embodiment, an aptamer-regulated nucleic acid is combined with a soluble extract derived from the Drosophila embryo, thereby producing a combination. The combination is maintained under conditions in which the dsRNA is processed to RNA molecules of about 21 to about 23 nucleotides.

The miRNA and siRNA molecules can be purified using a number of techniques known to those of skill in the art. For example, gel electrophoresis can be used to purify such molecules. Alternatively, non-denaturing methods, such as non-denaturing column chromatography, can be used to purify the siRNA and miRNA molecules. In addition, chromatography (e.g., size exclusion chromatography), glycerol gradient centrifugation, and affinity purification with antibody can be used to purify siRNAs and miRNAs.

In certain preferred embodiments, at least one strand of the siRNA sequence of an effector domain has a 3′ overhang from about 1 to about 6 nucleotides in length, though may be from 2 to 4 nucleotides in length. More preferably, the 3′ overhangs are 1-3 nucleotides in length. In certain embodiments, one strand may have a 3′ overhang and the other strand may be blunt-ended or have an overhang. The length of the overhangs may be the same or different for each strand. In order to further enhance the stability of the siRNA sequence, the 3′ overhangs can be stabilized against degradation. In one embodiment, the RNA is stabilized by including purine nucleotides, such as adenosine or guanosine nucleotides. Alternatively, substitution of pyrimidine nucleotides by modified analogues, e.g., substitution of uridine nucleotide 3′ overhangs by 2′-deoxythyinidine is tolerated and does not affect the efficiency of RNAi. The absence of a 2′ hydroxyl significantly enhances the nuclease resistance of the overhang in tissue culture medium and may be beneficial in vivo.

In certain embodiments, an aptamer-regulated nucleic acid is in the form of a hairpin structure (named as hairpin RNA). The hairpin RNAs can be synthesized exogenously or can be formed by transcribing from RNA polymerase III promoters in vivo. Examples of making and using such hairpin RNAs for gene silencing in mammalian cells are described in, for example, Paddison et al., Genes Dev. 16: 948-958, 2002; McCaffrey et al., Nature 418: 38-39, 2002; McManus et al., RNA 8: 842-850, 2002; Yu et al., Proc Natl Acad Sci USA 99: 6047-6052, 2002. Preferably, such hairpin RNAs are engineered in cells or in an animal to ensure continuous and stable suppression of a desired gene. It is known in the art that miRNAs and siRNAs can be produced by processing a hairpin RNA in the cell.

In yet other embodiments, a plasmid is used to deliver the double-stranded RNA, e.g., as a transcriptional product. After the coding sequence is transcribed, the complementary RNA transcripts base-pair to form the double-stranded RNA.

(iv) Ribozyme Sequences as Effector Domains

Ribozymes are RNA molecules that exhibit a range of different catalytic activities, most commonly cleavage of nucleic acid molecules. The hammerhead ribozyme is a small catalytic RNA that binds and cleaves virtually any complementary RNA molecule. Within a nucleic acid switch platform, the cleavage activity of a hammerhead ribozyme may be regulated by the binding of a ligand to an aptamer domain within the switch molecule. Thus a ribozyme may also be a functional domain of the subject aptamer-regulated nucleic acid.

Specifically, the binding of the ligand to the aptamer domain regulates the binding between two different switchable stems within the molecule, which regulate the correct formation of the catalytic core and targeting arms of the hammerhead ribozyme. If the ribozyme switch is in a conformation in which the correct catalytic core and targeting arms (i.e., the functional domain in this case) are formed, the molecule can then bind and effectively cleave its substrate (including self-cleavage). If the ribozyme switch is in a conformation in which the catalytic core and targeting arms are not correctly formed, the molecule will be unable to bind and cleave its target.

The ribozyme switch provides an extremely programmable and flexible platform. The aptamer domain of the ribozyme switch can be altered without changing the activity of the ribozyme domain of the molecule. This flexibility enables ribozyme switches to be readily designed to take different biochemical inputs, such as proteins and small molecules, as aptamers to different targets can be placed in the platform. In addition, the targeting arms of the ribozyme switch can be readily altered to target different RNA target molecules. This flexibility enables the ribozyme switches to be readily designed to bind to and cleave different RNA targets. Finally, as in similar aptamer-regulated nucleic acid platforms, the concentrations at which these molecules bind to their ligand molecules to induce conformational switching can be programmed by thermodynamic tuning strategies and altering the binding affinities of the aptamers.

Trans-acting ribozymes have demonstrated high specificity (compared to siRNAs or shRNAs) and high efficacy (compared to antisense oligonucleotides). When expressed from pol III promoters these molecules will enable long-term targeted cellular engineering strategies, in vivo biosensors, and therapeutics. In addition, exogenously delivered trans-acting ribozymes are currently being used in clinical trials as anti-angiogenic therapies. As such, the ribozyme switch platform can be used to create transient nucleic acid therapies that will enable targeting of the drugs effects to particular cellular states and environments.

As in the other aptamer-regulated nucleic acids, the catalytic activity of the ribozyme domain of a ribozyme switch is controlled via conformational switching of the catalytic core. Ribozyme switch constructs are designed such that formation of the necessary catalytic core structure is controlled through ligand binding to an aptamer domain, which regulates the binding of two switching stems. For example, a theophylline-regulated ribozyme switch can be designed such that a conformational rearrangement takes place upon ligand (theophylline) binding. Under conditions of high concentration of theophylline, the ribozyme switch functions as an on switch, and gene expression is turned on. The functional activity of a theophylline-responsive ribozyme “on” switch can be assayed by expression of GFP, when GFP and the ribozyme switch constructs can be expressed from galactose-inducible promoters in Saccharomyces cerevisiae. Conversely, the ribozyme switch platforms can be rationally designed to alter switching behavior such that a theophylline responsive “off” switch is created.

### EXAMPLES

Having generally described the invention, Applicants refer to the following illustrative examples to help to understand the generally described invention. These specific examples are included merely to illustrate certain aspects and embodiments of the present invention, and they are not intended to limit the invention in any respect. Certain general principles described in the examples, however, may be generally applicable to other aspects or embodiments of the invention.

### Example 1 Switch Design

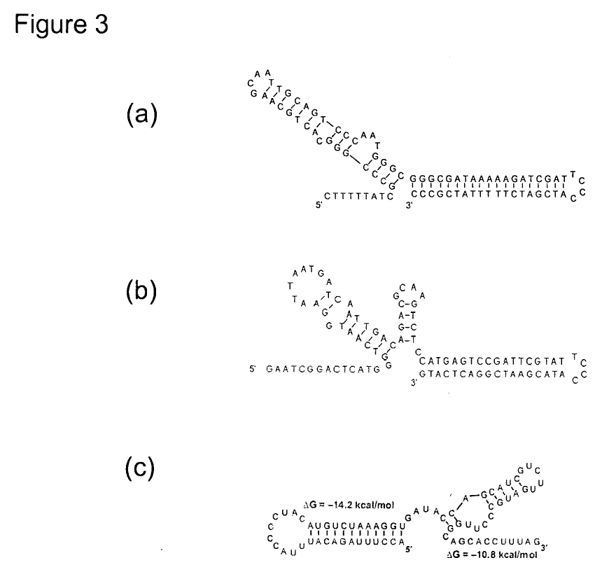

Three exemplary switch designs (FIG. 3) were developed to investigate the direct CE-based selection of switches. The PDGF switch is a protein-responsive DNA switch, the trans-androsterone switch is a small molecule-responsive DNA switch, and the theophylline switch is a small molecule-responsive RNA switch. The sequences of the switches and their corresponding linker sequences are included in FIG. 4. The Δ(ΔG) values tabulated are the difference between the ΔG for the hybridization of the aptamer switching strand with the complementary strand, and the combined ΔG for the hybridization of the competing strand with the complementary strand and the ΔG for the hybridization of the antisense stem, as pictured in FIG. 3c.

### Example 2 DNA Switches with Protein Targets

Proof-of-principle control studies for direct selection of molecular switches have been performed to demonstrate CE-based partitioning of a protein-responsive molecular switch. Fluorescein-labeled control switches were made through direct DNA synthesis for the PDGF switch. These switches were heat denatured and allowed to slowly cool to room temperature to ensure proper folding of the switch structures. An equilibrium mixture containing 2.5 μM PDGF switch and 1 μM PDGF was incubated at room temperature for a minimum of 30 minutes. As anticipated, a peak is detected that has shifted from the DNA switch peak and is observed in the CE-based partitioning run only when the sample contains the PDGF switch and PDGF, indicating binding between the control switch and its protein ligand. These controls support the feasibility of using CE-based separations for the direct partitioning of switch-protein ligand complexes.

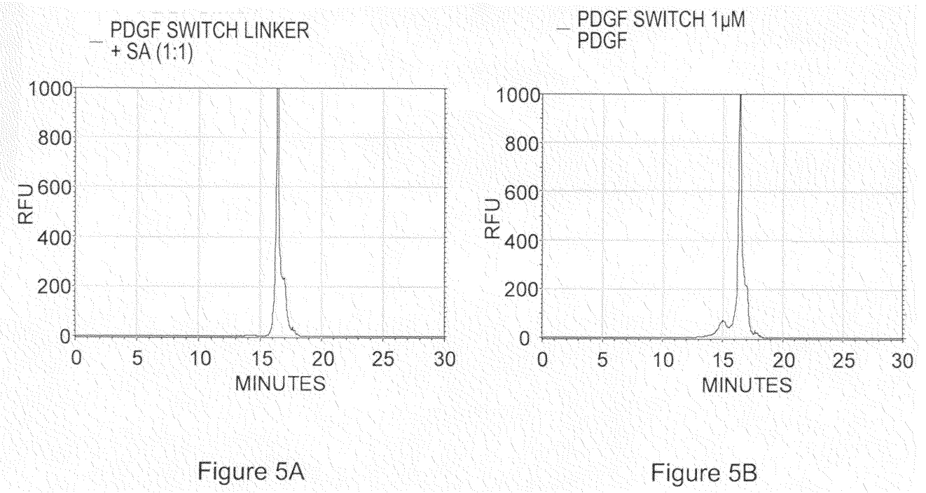

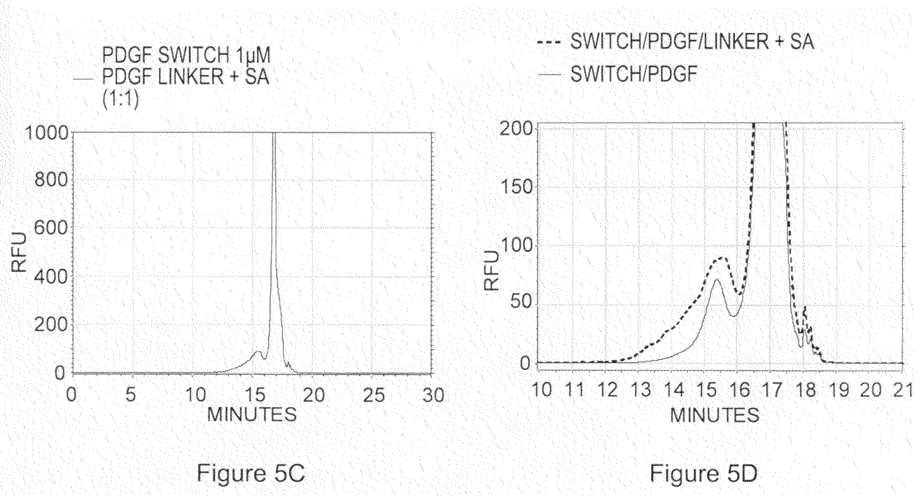

Further testing was done to demonstrate that addition of a linker-Streptavidin complex would also induce a shift upon binding, since this is advantageous for the selection of small-molecule responsive switches (FIG. 5). A one-to-one mixture of the linker-Streptavidin complex with the PDGF switch does not produce a distinct shifted peak, indicating that background binding of the switch to the linker-Streptavidin complex without any PDGF protein present is very low. When PDGF is included along with this 1:1 mixture of linker-Streptavidin complex and PDGF switches, a shifted peak is visible, corresponding to the PDGF protein bound to the PDGF switch/linker-Streptavidin complex. Furthermore, comparison to the shifted peak for PDGF switch with PDGF only shows that the addition of the linker-Streptavidin complex increases the amount of switch that gets shifted, and the observable amount by which it is shifted as evidenced by a larger total area, calculated via the 32 Karat Software Peak Analysis Program, from the free DNA switch peak (supporting a larger change in the m/z ratio) on the electropherogram.

### Example 3 DNA Switches with Small Molecule Targets

Similar proof-of-principle control studies for the direct selection of molecular switches have been done to demonstrate CE-based partitioning of a small molecule-responsive molecular switch. The binding event between a molecular switch and its small molecule ligand may be insufficient to change the electrophoretic mobility of the complex from that of the switch alone. Therefore, the binding event may be advantageously coupled through the change in switch conformation to another binding event. For example, the single-stranded output functional domain of the switch may bind to a target oligonucleotide that is linked to a Streptavidin molecule via a biotin label. This selection scheme has been demonstrated using a synthesized trans-androsterone control switch and the corresponding oligonucleotide target.

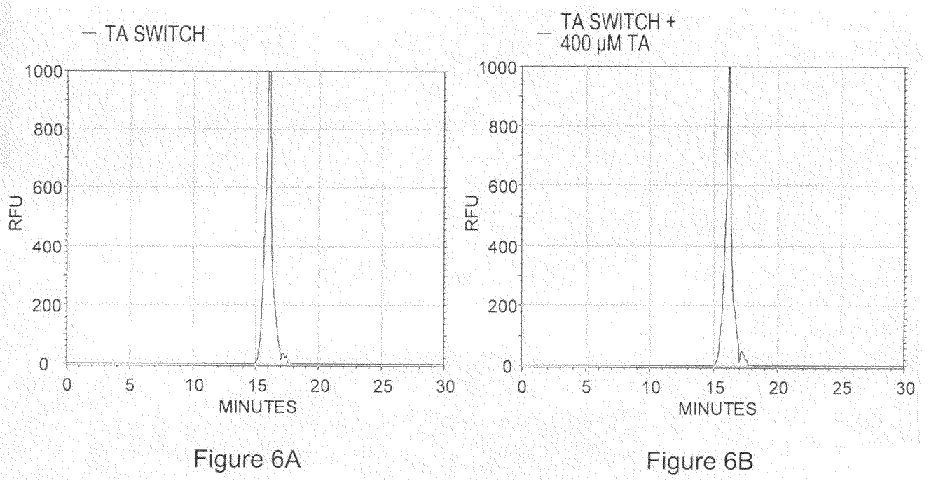

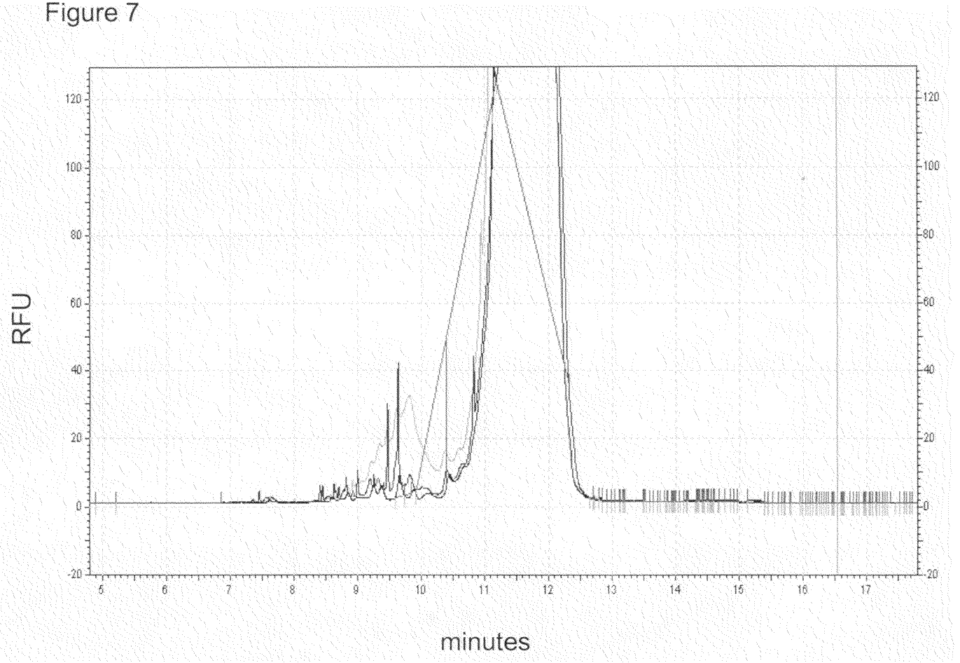

In this particular example, equilibrium mixtures containing only switch and trans-androsterone did not give a shifted complex peak (FIG. 6). This result is not surprising, since this small molecule is not able to sufficiently alter the electrophoretic mobility of the switches to give separation with CE. However, addition of the linker-Streptavidin complex is sufficient to change the electrophoretic mobility of bound switches and allow separation of bound switches from unbound switches for the selection of small molecule-responsive switches using CE (FIG. 7). Control trials were completed using a sample of the switch and linker-Streptavidin complex without trans-androsterone in which there is no significant observable shift (FIG. 7).

In total, these results show that the addition of the linker-Streptavidin complex is necessary for effectively altering the m/z ratio of the tested small molecule-binding switch in its complex form, and that the complex peak shifts are sufficient to set collection windows for partitioning.

### Example 4 RNA Switches

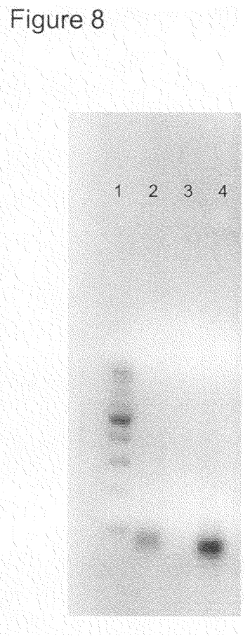

RNA switches behave similarly as the DNA switches discussed above. Specifically, we designed a theophylline-responsive RNA switch (see FIG. 3c). Data shows that this switch can be successfully amplified and transcribed (FIG. 8), and the appropriate biotin-labeled linker has been synthesized for use in the small-molecule switch selection scheme described above. CE partitioning tests are performed with this switch.

### Example 5 RNA Aptamers

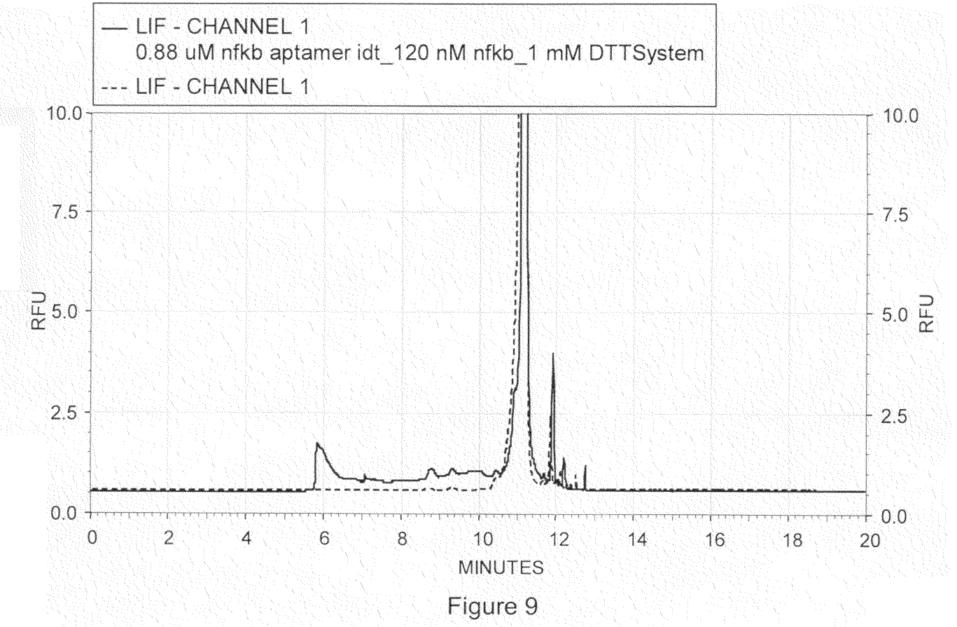

An RNA aptamer for the protein NF-kB was synthesized, both with and without a 5′ fluorescein label for use with the UV detection and LIF detection respectively. When the NF-kB protein was incubated with the RNA aptamer, a distinct shift was seen as compared to the aptamer alone, indicating binding between the aptamer and the protein. Moreover, the separation time between the shifted peaks allows for effective partitioning of the bound complexes from the unbound RNA using CE. FIG. 9 shows the effective separation of bound complex and unbound aptamer peaks using LIF detection.

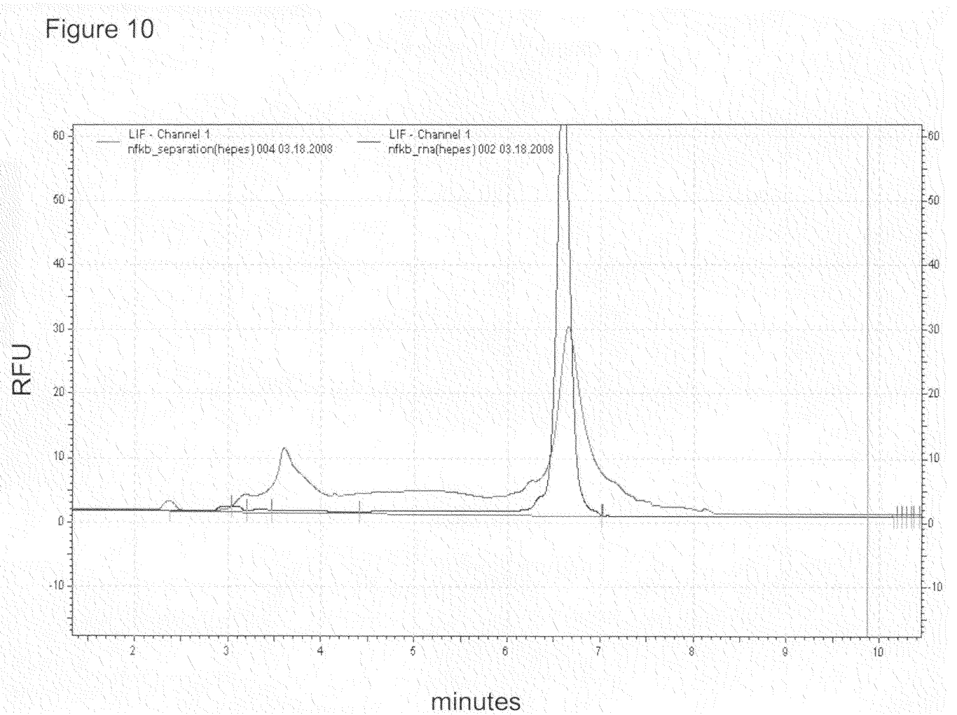

FIG. 10 shows a similar result using a modified CE separation method that incorporates a higher voltage application and shorter capillary length. The benefit of the latter partitioning methods is, as the mixture is run through the capillary at a faster rate, fewer of the bound sequences will have an opportunity to disassociate during the course of the run such that more of functional binding sequences will remain in a complex and subsequently be collected, increasing the enrichment in early rounds of selection. There is a decrease in the total migration time between the shifted complex peak and the unbound free RNA aptamer peak during separation runs where the migration time is much faster than previously shown. Specifically, in FIG. 9 the migration times of the complex peak and unbound peak are 5.9 minutes and 10.9 minutes respectively, thus the difference in migration times is 5 minutes. However, in FIG. 10, the capillary is subjected to higher voltage and the difference in migration times is reduced to 3 minutes between the complex and unbound peak.

Thus in certain embodiments, CE separation is enhanced by using higher voltage and/or shorter capillary length. One unexpected advantage of this separation scheme is that shorter migration times appear to allow for the collection of a greater number of bound sequences by decreasing the likelihood that the sequences will dissociate as they migrate through the capillary. For example, although a higher concentration (2-fold) of NF-kB protein is used in FIG. 10 than in FIG. 9, the complex peak area is more than 4 times greater relative to a proportional increase of only two times for the concentration.

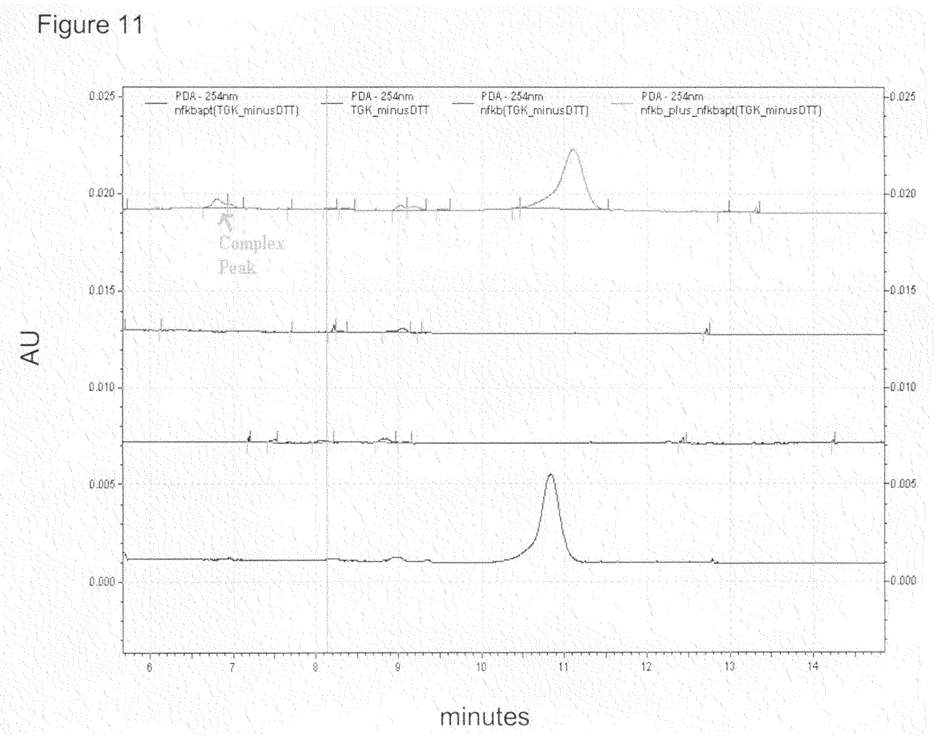

Results of partitioning runs monitored at 254 nm using the PDA detector also show a distinct shifted complex peak in the NF-kB plus NF-kB aptamer equilibrium mixture as compared to NF-kB aptamer only (FIG. 11). These results verify both the formation of a distinct complex peak due to changes in electrophoretic mobility of the bound complex peak, and that there is significant difference in migration time to partition the bound and unbound sequences.

The differences in migration time of the bound and unbound sequences are further used to determine relevant collection times in order to select out the highest affinity and most specific sequences to the NF-kB protein and other targets.

In another set of experiments, the NF-kB RNA aptamer is spiked into a larger random N40 RNA library. The NF-kB aptamer-library mixture is incubated at 75° C. for 10 minutes, followed by addition of the NF-kB protein and incubation of the equilibrium mixture at 37° C. for 30 to 45 minutes. Using this equilibrium mixture, three collection times—C1, D1, E1—were determined from the CE electropherogram such that bound sequences would be collected in C1, unbound sequences collected in D1, and little to no sequences should be found in E1, if the collection times are determined accurately. Three consecutive runs were performed on the CE before reverse transcription-PCR (RT-PCR).

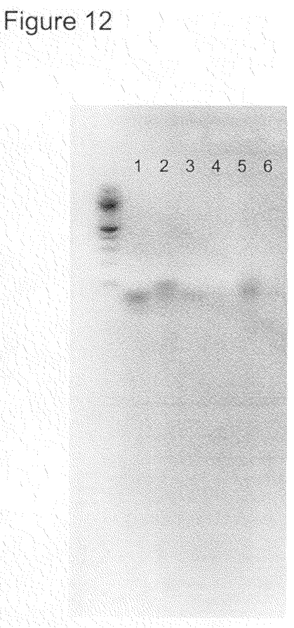

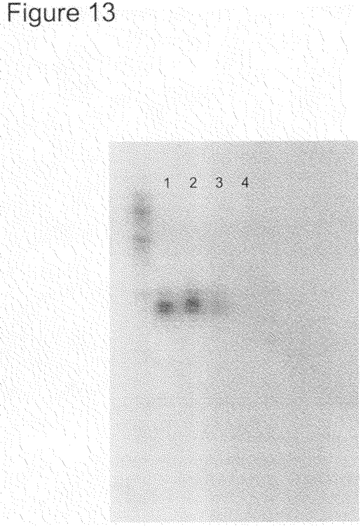

Based on the known selectivity of the NF-kB aptamer, it is expected that the first collection will primarily contain NF-kB aptamer and little to none of the random N40 sequences (FIG. 12). Before proceeding to a second round of selection, transcription of the RT-PCR samples is performed using a reverse transcription kit, and the Ampliscribe T7 transcription kit from Epicentre Biotechnologies (FIG. 13).

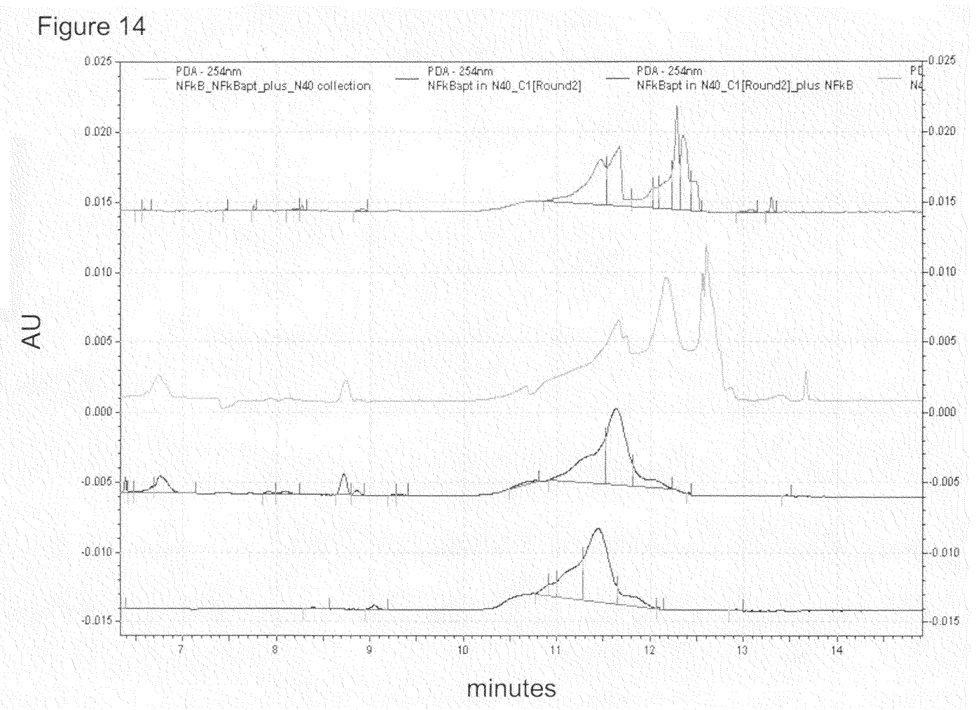

Following RT-PCR and transcription, the new aptamer mixture should be enriched with NF-kB aptamer sequences and a shifted complex is observed nearly identical to the first round of selection (FIG. 14). Due to relatively low ratio of NF-kB aptamer and random N40 RNA library in the initial mixture for the first round of selection, enrichment in the second round with respect to complex peak formation is not expected to vary greatly. However, the unbound RNA peak should appear significantly different relative to the first round of selection, since the NF-kB aptamer and N40 RNA library have distinct peak profiles at 254 nm. The second round selection sample using the C1 collection sample should primarily contain the NF-kB aptamer (FIG. 14). Although the CE electropherogram can show enrichment to some extent, cloning and sequencing of the selected bound aptamers must be performed to further verify these results. These results show successful partitioning, amplification, and transcription of bound sequences for further selection cycles can be accomplished for RNA aptamers.

### INCORPORATION BY REFERENCE

All references cited herein are hereby incorporated by reference in their entirety.

We claim:

1. A method of screening a library of nucleic acids for a nucleic acid that binds a ligand, wherein each member of said library comprises:
(a) an aptamer that potentially binds the ligand; and,
(b) a functional domain,
the method comprising:
(1) contacting the library of nucleic acids with the ligand, under conditions that allow binding of the ligand to the aptamer of one or more members of the library in solution;
(2) isolating nucleic acids that form complexes with the ligand; and,
(3) determining, for each nucleic acids isolated in (2), if any, whether binding of the ligand to said aptamer favors a conformational change in the functional domain from a first ligand-free conformation to a second ligand-bound conformation,
wherein the functional domain is not a ribozyme or a catalytic RNA, or wherein step (2) is not effectuated by denaturing polyacrylamide gel electrophoresis (PAGE) or a chromatography-based selection system, or both.

2. The method of claim 1, further comprising repeating once or more times steps (1)-(2) before step (3), or repeating once or more times steps (1)-(3), each time using any nucleic acids isolated in step (2) of the previous iteration or an amplification product thereof as the library in the immediate subsequent round of screening.

3. The method of claim 1, wherein said conformational change is caused by a strand displacement mechanism, wherein in the first conformation, a complementary strand base pairs with a competing strand, and in the second conformation, an aptamer switching stem displaces the competing strand to base pair with the complementary strand.

4. The method of claim 1, wherein each member of said library of nucleic acids comprises:
(i) the aptamer,
(ii) a complementary strand,
(iii) an aptamer switching stem,
(iv) a competing strand,
(v) an antisense stem, and,
wherein, in the first conformation, the aptamer unbound by the ligand allows said competing strand to base pair with said complementary strand, and said antisense stem to form a double-stranded stem-loop structure;
wherein, in the second conformation, the aptamer bound by the ligand allows said aptamer switching stem to displace said competing strand and base pair with said complementary strand, and disrupts the stem-loop structure formed from the antisense stem.

5. The method of claim 4, wherein the aptamer is flanked by the complementary strand and the aptamer switching stem.

6. The method of claim 5, wherein the aptamer is 3′ to the complementary strand.

7. The method of claim 4, wherein, in the second conformation, the antisense stem is without the stem-loop structure and is capable of hybridizing with a second polynucleotide.

8. The method of claim 1, wherein step (2) is carried out based on the mass-to-charge (m/z) ratio difference among the complexes, the unbound ligand, and the unbound nucleic acid.

9. The method of claim 3, wherein step (2) is carried out based on the availability of the competing strand for hybridization with a second polynucleotide.

10. The method of claim 1, wherein members of said library of nucleic acids have substantially the same m/z ratio.

11. The method of claim 1, wherein each member of said library of nucleic acids has essentially the same length.

12. The method of claim 1, wherein the ligand is a polypeptide.

13. The method of claim 1, wherein the ligand is a small molecule no more than 5 kDa in molecular weight.

14. The method of claim 13, further comprising, before step (2):
(4) contacting the mixture with a second nucleic acid that binds to the functional domain after but not before said conformational change.

15. The method of claim 14, wherein the second nucleic acid is conjugated to a label.

16. The method of claim 15, wherein the label is biotin or a fluorescent label.

17. The method of claim 16, wherein the second nucleic acid is conjugated to biotin, and the method further comprising, before step (2):
(5) contacting the mixture with Avidin, Streptavidin, or an analog thereof.

18. The method of claim 1, wherein step (2) is carried out by capillary electrophoresis (CE).

19. The method of claim 18, wherein said CE is non-equilibrium CE.

20. The method of claim 1, wherein said aptamer comprises a randomized sequence.

21. The method of claim 20, wherein said randomized sequence is about 30-50 nucleotides in length, or 10-60 nucleotides in length.

22. The method of claim 1, wherein the functional domain comprises a priming sequence capable of hybridizing to a target template to form a primer:template pair, and wherein binding of the ligand to said aptamer favors a conformational change in the nucleic acid that alters the ability of said priming sequence to hybridize to said target template.

23. The method of claim 22, wherein said primer:template pair is a substrate for an extrinsic enzymatic activity.

24. The method claim 22, wherein said conformational change produces or removes an intramolecular double-stranded feature, including said priming sequence, which double-stranded feature alters the availability of said priming sequence to hybridize to said target template.

25. The method of claim 1, wherein said functional domain is:
(1) a substrate sequence that can form a substrate for an extrinsic enzyme, and
(2) binding of said ligand to said aptamer favors a conformational change in the nucleic acid that alters the ability of said substrate sequence to form said substrate and/or alters the Kₘ and/or k_{cat} of said substrate for the extrinsic enzymatic activity.

26. The method of claim 25, wherein the conformational change produces or removes an intramolecular double-stranded feature, including said substrate sequence, which double-stranded feature is said substrate for said extrinsic enzyme.

27. The method of claim 25, wherein said extrinsic enzyme is Dicer.

28. The method of claim 27, wherein said substrate sequence produces siRNA, miRNA or a precursor or metabolite thereof in an RNA interference pathway, as a product of reaction with Dicer.

29. The method of claim 25, wherein the conformation change alters the ability of the substrate sequence to form an intermolecular double-stranded feature with a second nucleic acid species, which double stranded feature is a substrate for said extrinsic enzyme.

30. The method of claim 29, wherein the second nucleic acid species is an mRNA, and said extrinsic enzyme alters the mRNA in a manner dependent on the formation of said double-stranded feature.

31. The method of claim 25, wherein the extrinsic enzyme is an RNase H enzyme and/or an RNase P enzyme.

32. The method of claim 25, wherein said substrate sequence comprises a hairpin loop.

33. The method of claim 1, wherein said functional domain is a ribozyme, and wherein binding of said ligand to said aptamer favors a conformational change in the nucleic acid that alters the activity of the ribozyme.

34. The method of claim 1, wherein said nucleic acid comprises one or more aptamers or one or more effector domains.

35. The method of claim 1, wherein said nucleic acid interacts with and responds to multiple ligands.

36. The method of claim 1, wherein said nucleic acid is a cooperative ligand controlled nucleic acid wherein multiple ligands sequentially bind to multiple aptamers to allosterically regulate one or more effector domains.


SEQUENCE LISTING (9 sequences)

SEQ ID NO: 1 - DNA, 87 bp, Artificial Sequence
  Description of Artificial Sequence Synthetic oligonucleotide
ctttttatcgcccgggcactgcaagcaattgcagtcccaatgggcgggcgataaaaagatcgattcccatcgatctttttatcgccc

SEQ ID NO: 2 - DNA, 94 bp, Artificial Sequence
  Description of Artificial Sequence Synthetic oligonucleotide
gaatcggactcatgggtcaatggaattaatgatcaattgacagacgcaagtctccatgagtccgattcgtattcccatacgaatcggactcatg

SEQ ID NO: 3 - RNA, 74 nt, Artificial Sequence
  Description of Artificial Sequence Synthetic oligonucleotide
accuuuagacauuuaccccuacaugucuaaaggugauaccagcaucgucuugaugcccuuggcagcaccuuuag

SEQ ID NO: 4 - DNA, 19 bp, Artificial Sequence
  Description of Artificial Sequence Synthetic oligonucleotide
gggcgataaaaagatcgat

SEQ ID NO: 5 - DNA, 18 bp, Artificial Sequence
  Description of Artificial Sequence Synthetic oligonucleotide
ctgcaatacgattcgtat

SEQ ID NO: 6 - DNA, 15 bp, Artificial Sequence
  Description of Artificial Sequence Synthetic oligonucleotide
taaatgtctaaaggt

SEQ ID NO: 7 - DNA, 87 bp, Artificial Sequence
  Description of Artificial Sequence Synthetic oligonucleotide
ctttttatcgcccgggcactgcaagcaattgtggtcccaatgggcgggcgataaaaagatcgattcccatcgatctttttatcgccc

SEQ ID NO: 8 - DNA, 90 bp, Artificial Sequence
  Description of Artificial Sequence Synthetic oligonucleotide
cgtattgcagggtcaatggaattaatgatcaattgacagacgcaagtctcctgcaatacgattcgtattcccatacgaatcgtattgcag

SEQ ID NO: 9 - RNA, 73 nt, Artificial Sequence
  Description of Artificial Sequence Synthetic oligonucleotide
accuuuagacauuuaccucuaaaugucuaaaggugauaccagcaucgucuugaugcccuuggcagcaccuuag